(19) United States
(12) Patent Application Publication
(10) Pub. No.: US 2026/0322320 A1
(43) Pub. Date: Oct. 15, 2026

(54) ADJUSTABLE CABLE MANAGEMENT DEVICE

(71) Applicant: ARRAY TECH, INC., Albuquerque, NM (US)

(72) Inventors: Shuo Chen, Chandler, AZ (US); Tyler Pronty, Laveen, AZ (US)

(21) Appl. No.: 19/637,951

(22) Filed: Apr. 2, 2026

Related U.S. Application Data
(60) Provisional application No. 63/786,717, filed on Apr. 10, 2025.

(51) Int. Cl. H02S 20/32; H02G 3/04

(52) U.S. Cl. CPC H02S 20/32; H02G 3/0456

(57) ABSTRACT

An adjustable cable management device may include a mounting bracket configured to be coupled to a center structure of a photovoltaic (PV) system. The adjustable cable management device may further include a bracket extension coupled to the mounting bracket. The adjustable cable management device may further include a means for selectively adjusting the bracket extension relative to the mounting bracket. A cable retention portion may be coupled to the bracket extension, and the cable retention portion may be configured to be coupled to one or more cables.

### CROSS-REFERENCE TO RELATED APPLICATIONS

This patent application claims priority to and the benefit of U.S. Provisional Patent Application Ser. No. 63/786,717, entitled ADJUSTABLE CABLE MANAGEMENT DEVICE, filed Apr. 10, 2025, which is incorporated by reference in its entirety.

### FIELD

The present disclosure relates to solar energy production and more particularly to an adjustable cable management device.

### BACKGROUND

Solar installations including solar farms, photovoltaic (PV) plants, solar tracking systems, fixed solar systems, and other PV systems often include large numbers of PV modules that collect sunlight and generate energy. PV systems may include a variety of electrical components that may be interconnected via cables (e.g., cables connecting a PV module to an inverter).

Solar tracker systems typically include multiple solar tracker rows and operate by rotating PV modules secured at each solar tracker row to align the PV modules with the position of the Sun. As a result, the PV modules' exposure to sunlight throughout the day may be increased. This functionality may ensure that PV modules in solar tracker systems remain positioned to capture higher levels of solar radiation, which may enhance the overall efficiency of solar power generation.

Because there are several moving components in solar tracking systems, cable management devices may need to be installed on center structures (e.g., a pile or mounting structure) within precise tolerances to ensure that the cables are not in the pathway of the moving components. For example, cable management devices may need to be installed at a specific height on the center structure and/or may need to have a specific length to ensure that the cables are not contacted by the moving PV modules, torque tubes, or other moving components in a solar tracker system. Installing a cable management device at an improper height and/or utilizing a cable management device with an improper length may lead to damaged cables, damaged components, and hazardous electrical conditions.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Cable management devices typically include a bracket which may be coupled to the center structure. However, the bracket may be installed at the wrong height and/or the wrong length of bracket may be ordered. To remedy these errors, the bracket is typically either removed and reinstalled or, if the existing bracket is not sufficient to meet the tolerances of the PV system, a new bracket may need to be ordered and installed. These remedies are time-consuming, labor intensive, and may result in significant downtimes for the PV system.

Accordingly, there is a need for a cable management device that allows the cable management device to be adjusted without having to remove and reinstall the cable management device or without having to order new components. An adjustable cable management device may allow the cables to be selectively adjusted to a different height and/or length relative to the center structure such that the cables are placed out of the path of the moving components of a solar tracking system. This selective adjustment may improve the overall safety, performance, and/or efficiency in solar tracking systems.

Example embodiments of the present disclosure may address problems experienced in PV systems, including the inability to adjust cable management devices without having to remove and reinstall the device or order new components. Embodiments disclosed herein may address these problems by providing an adjustable cable management device including a mounting bracket configured to be coupled to a center structure of a PV system, a bracket extension coupled to the mounting bracket, a cable retention portion coupled to the bracket extension, and a means for selectively adjusting the bracket extension relative to the mounting bracket. By allowing for the adjustment of the bracket extension relative to the mounting bracket, the position of the cables in a PV system may be adjusted such that the cables are within the precise tolerances of the PV system. As a result, damage to the cables and/or the components of the PV system may be mitigated and/or prevented.

In some embodiments, the mounting bracket may include one or more apertures and the bracket extension may include one or more apertures. In some embodiments, the means for selectively adjusting the bracket extension relative to the mounting bracket may be a fastener that extends through at least one of the one or more apertures of the mounting bracket and at least one of the one or more apertures of the bracket extension such that the bracket extension is adjustable relative to the mounting bracket when the fastener is loosened, disengaged, or removed. In some embodiments, the bracket extension may include at least two apertures configured to receive the fastener. In these and other embodiments, the at least two apertures may be distributed at a distance along a length of the bracket extension. In some embodiments, the mounting bracket may include one aperture and the aperture may be a slot.

In some embodiments, the mounting bracket may include a first arm having a first aperture and a second arm having a second aperture. In some embodiments, the bracket extension may be positioned between the first arm and the second arm such that the fastener may extend through the first aperture, through at least one of the one or more apertures of the bracket extension, and through the second aperture. In some embodiments, the first aperture and the second aperture may be slots. In some embodiments, the bracket extension may include at least two apertures distributed at a distance along a length of the bracket extension, and the at least two apertures may be configured to receive the fastener.

In some embodiments, the means for selectively adjusting the bracket extension relative to the mounting bracket may be a bearing positioned between the mounting bracket and the bracket extension. For example, in some embodiments, the mounting bracket may include a first guiderail, the bracket extension may include a second guiderail mated with the first guiderail, and the bearing may be positioned between the first guiderail and the second guiderail. In another example, the mounting bracket may include a protrusion or a recess, the bracket extension may include a sliding carriage, and the bearing may be configured to engage the protrusion or recess such that the bearing is positioned between the mounting bracket and the sliding carriage.

In some embodiments, the mounting bracket may include an outer tube, the bracket extension may include an inner tube disposed at least partially within the outer tube, and the means for selectively adjusting the bracket extension relative to the mounting bracket may be an outer diameter of the inner tube being lesser than an inner diameter of the outer tube.

In some embodiments, the means for selectively adjusting the bracket extension relative to the mounting bracket may include a pivot joint coupling the bracket extension to the mounting bracket. In some embodiments, the mounting bracket may include a first arm having two or more apertures and a second arm having two or more apertures such that each of the apertures of the second arm align with an aperture of the first arm. In these and other embodiments, the bracket extension may be positioned between the first arm and the second arm, and a fastener may extend through an aperture of the first arm, an aperture of the second arm, and an aperture of the bracket extension. In some embodiments, the two or more apertures of the first arm and the second arm may be aligned with the rotational trajectory of the bracket extension about the pivot joint. In some embodiments, the means for selectively adjusting the bracket extension relative to the mounting bracket may further include one or more linkages coupling the bracket extension to the pivot joint.

In some embodiments, the mounting bracket may include a fastener having a set of threads, the bracket extension may include a traveler having a corresponding set of threads, and the means for selectively adjusting the bracket extension relative to the mounting bracket may be engagement of the set of threads with the corresponding set of threads. For example, when the set of threads and the corresponding set of threads are threaded together in a first direction, the traveler may be mobilized in a first direction. In another example, when the set of threads and the corresponding set of threads are threaded together in a second direction, the traveler may be mobilized in a second direction.

In some embodiments, the means for selectively adjusting the bracket extension relative to the mounting bracket may include a piston coupled to the mounting bracket and the bracket extension. In these and other embodiments, the piston may adjust the bracket extension in a first direction when the piston is stroked in a first direction, and the piston may adjust the bracket extension in a second direction when the piston is stroked in a second direction.

In some embodiments, the means for selectively adjusting the bracket extension relative to the mounting bracket may include one or more flexural joints extending from an outer surface of the bracket extension, and the one or more flexural joints may contact an inner surface of the mounting bracket. In these and other embodiments, the flexural joints may be configured to adjust the bracket extension to a first position when engaged in a first direction and to a second position when engaged in a second direction.

In some embodiments, the mounting bracket may include an engaging portion configured to engage a receiving portion of the center structure. For example, the mounting bracket may include a hook, and the center structure may include a slot that receives the hook such that the mounting bracket may be coupled to the center structure. In some embodiments, the cable retention portion may be a clamp. In some embodiments, the cable retention portion may be coupled to a messenger line, and the messenger line may be coupled to one or more cable hangers configured to receive one or more cables.

Overall, the means for selectively adjusting the bracket extension relative to the mounting bracket may improve cable management in PV systems. For example, the amount of downtime in PV systems may be reduced by allowing the cable management device to be adjusted without having to remove the cable management device and/or without having to order new components. Furthermore, the ability to adjust the bracket extension may ensure safer and more effective operation of PV systems by allowing electrical components to be moved out of the pathway of moving components.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is a perspective view of a PV system including an adjustable cable management device;

FIG. 2 is a partial view of another PV system illustrating an adjustable cable management device coupled to a center structure of the PV system;

FIG. 3 is a partial view of another PV system illustrating an adjustable cable management device coupled to the center structure of the PV system;

FIG. 4A is a perspective view of an adjustable cable management device;

FIG. 4B is an exploded view of the adjustable cable management device of FIG. 4A;

FIG. 5A is a perspective view of another adjustable cable management device in which the cable retention portion is a clamp;

FIG. 5B is a perspective view of another adjustable cable management device in which the cable retention portion is upwardly extending;

FIG. 5C is a perspective view of another adjustable cable management device in which the cable retention portion is a hook;

FIG. 6A is a perspective view of another adjustable cable management device;

FIG. 6B is an exploded view of the adjustable cable management device of FIG. 6A;

FIGS. 7-16 illustrate various means for selectively adjusting a bracket extension relative to a mounting bracket in an adjustable cable management device.

All in accordance with one or more embodiments in the present disclosure.

### DETAILED DESCRIPTION

Embodiments of the present disclosure are explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

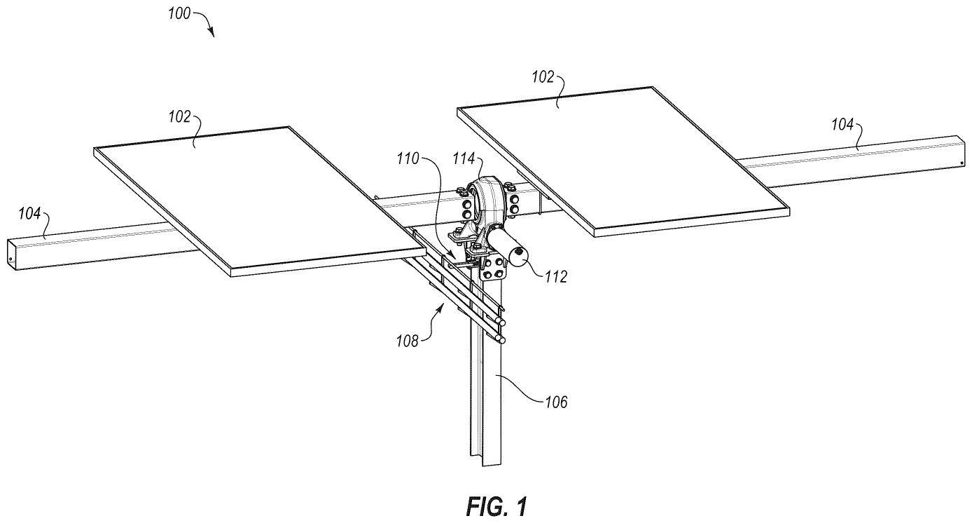

FIG. 1 illustrates an example photovoltaic system 100. The example photovoltaic system 100 may include PV modules 102, a torque tube 104, and a center structure (or pile) 106. The center structure 106 may be driven into the ground and may provide vertical support for the torque tube 104 and the PV modules 102. The torque tube 104 may provide horizontal support to the PV modules 102, and the torque tube 104 may be rotated by a motor 112 (e.g., an AC motor or a DC motor) and/or a gear drive mechanism 114 (e.g., a slew drive). The PV modules 102 may be coupled to the torque tube 104 such that the rotation of the torque tube 104 may be translated to the PV modules 102 enabling the PV modules 102 to track the position of the Sun in the sky throughout the day. For example, as the Sun rises and early in the day, the PV modules 102 may be rotated by the torque tube 104 such that the PV modules 102 are facing an easterly direction, around mid-day the PV modules 102 may be horizontal, and, as the Sun sets and later in the day, the PV modules 102 may be rotated by the torque tube 104 such that the PV modules 102 are facing a westerly direction. Additionally or alternatively, the PV modules 102 may be rotated by the torque tube 104 in response to weather events such as hailstorms or snowstorms, for maintenance purposes, and/or in response to other factors other than to track the position of the Sun.

An adjustable cable management device 110 may be coupled to the center structure 106. The adjustable cable management device 110 may be configured to support one or more cables 108 utilized in the PV system 100. For example, the adjustable cable management device 110 may be configured to support one or more DC cables, AC cables, grounding cables, extension cables (e.g., MC4 extension cables), or any other cable that may be included in a solar installation.

The adjustable cable management device 110 may allow the position of one or more cables 108 to be adjusted relative to the center structure 106 such that the one or more cables 108 may be installed within the tolerances of the PV system 100 and/or out of the path of the moving components of the PV system 100 such as the PV modules 102 and/or the torque tube 104. The adjustable cable management device 110 may be vertically, diagonally, and/or horizontally adjusted.

The adjustable cable management device 110 may include a mounting bracket (not shown). The mounting bracket may couple the adjustable cable management device 110 to the center structure 106 of the PV system 100. For example, the mounting bracket may include an engaging portion that may engage a receiving portion of the center structure 106. In some embodiments, the engaging portion may be a hook and the receiving portion may be a slot. In some embodiments, the engaging portion may be a hanger, a clip, a fastener, a protrusion, or any other engagement mechanism that may couple the mounting bracket to the center structure 106. In some embodiments, the receiving portion may be an aperture (e.g., a hole or a slot), a recess, a channel, a groove, or any other receiving mechanism that may receive the engaging portion of the mounting bracket.

The adjustable cable management device 110 may further include a bracket extension, which may be coupled to the mounting bracket. The bracket extension may extend vertically and/or horizontally from the center structure 106. The bracket extension may be selectively adjusted relative to the mounting bracket. In some embodiments, the bracket extension may be horizontally adjustable relative to the mounting bracket. For example, the bracket extension may be adjusted side to side (e.g. left to right or right to left) relative to the mounting bracket. In another example, the bracket extension may be inwardly adjusted relative to the mounting bracket such that the bracket extension is adjusted toward the center structure 106 or the bracket extension may be outwardly adjusted relative to the mounting bracket such that the bracket extension is adjusted away from the center structure 106. In some embodiments, the bracket extension may be vertically adjustable relative to the mounting bracket. For example, the bracket extension may be upwardly adjusted relative to the mounting bracket such that the bracket extension is adjusted towards the torque tube 104 or the bracket extension may be downwardly adjusted relative to the mounting bracket such that the bracket extension is adjusted toward the ground.

In some embodiments, the bracket extension may be adjusted vertically and horizontally at the same time (e.g., adjusted diagonally). In some embodiments, vertical and horizontal adjustment of the bracket extension may be independent adjustments (e.g., the bracket extension may be vertically adjusted without being horizontally adjusted).

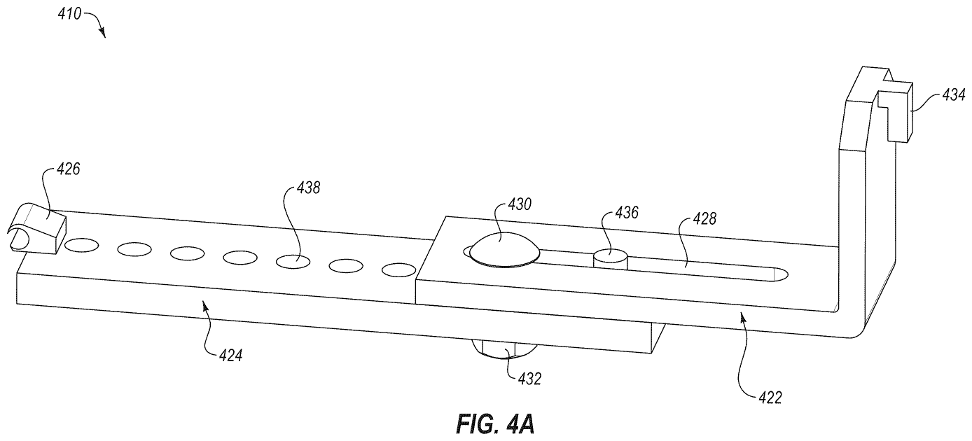

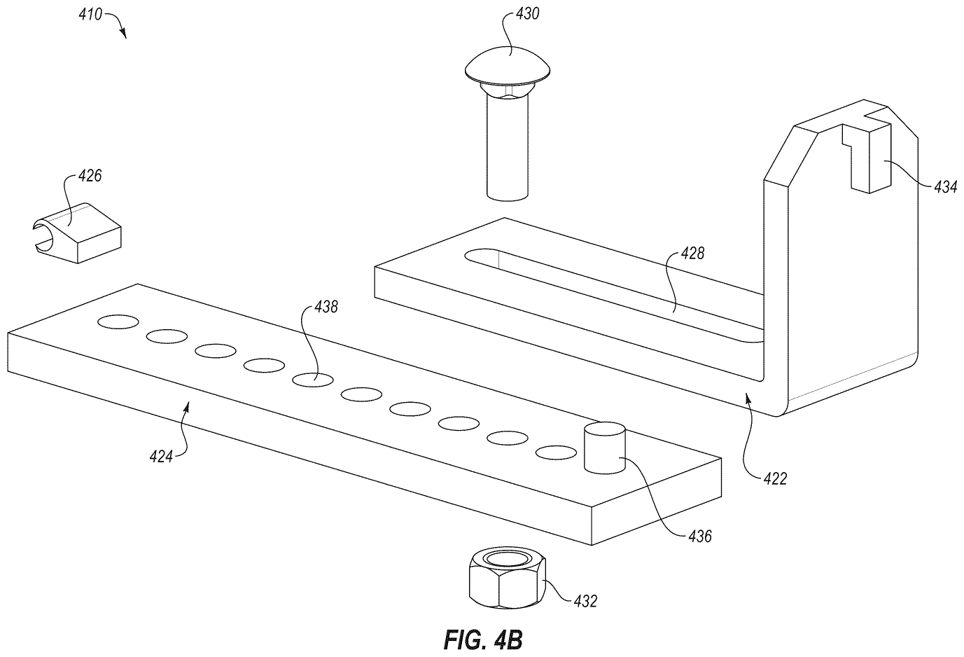

The adjustable cable management device 110 may further include a means for selectively adjusting the bracket extension relative to the mounting bracket (not shown). In some embodiments, the mounting bracket may include one or more apertures, and the bracket extension may include one or more apertures. In some embodiments, the means for selectively adjusting the bracket extension may be a fastener that extends through at least one of the one or more apertures of the mounting bracket and at least one of the one or more apertures of the bracket extension such that the bracket extension is adjustable relative to the mounting bracket when the fastener is loosened, disengaged, or removed. For example, the fastener may be removed from the one or more apertures of the bracket extension such that the bracket extension may be adjusted relative to the mounting bracket. In another example, the one or more apertures of the mounting bracket may be a slot, and the fastener may be loosened such that the fastener may be mobilized along the slot, which may adjust the position of the bracket extension relative to the mounting bracket. The term fastener as used in this disclosure may encompass bolt, a screw, a dowel, a pin, a rod, a shaft, a rivet, or any other suitable fastener that may secure two components together. Furthermore, the term fastener may encompass a nut, a pin, a lock washer, a clip, a ring, a collar, or any other suitable fastener that may retain and/or correspond to another fastener. The above described embodiments are described in more detail with reference to FIGS. 4-9.

In some embodiments, the bracket extension may include at least two apertures distributed at a distance along a length of the bracket extension, and the at least two apertures may be configured to receive the fastener. Thus, the fastener may be removed from one of the at least two apertures of the bracket extension and placed in another aperture at a different position on the bracket extension such that the bracket extension may be adjusted relative to the mounting bracket. In some embodiments, the mounting bracket may include a first arm having a first aperture and a second arm having a second aperture. In these and other embodiments, the bracket extension may be positioned between the first arm and the second arm, and the fastener may extend through the first aperture, through at least one of the one or more apertures of the bracket extension, and through the second aperture. In some embodiments, the first aperture and the second aperture may be slots.

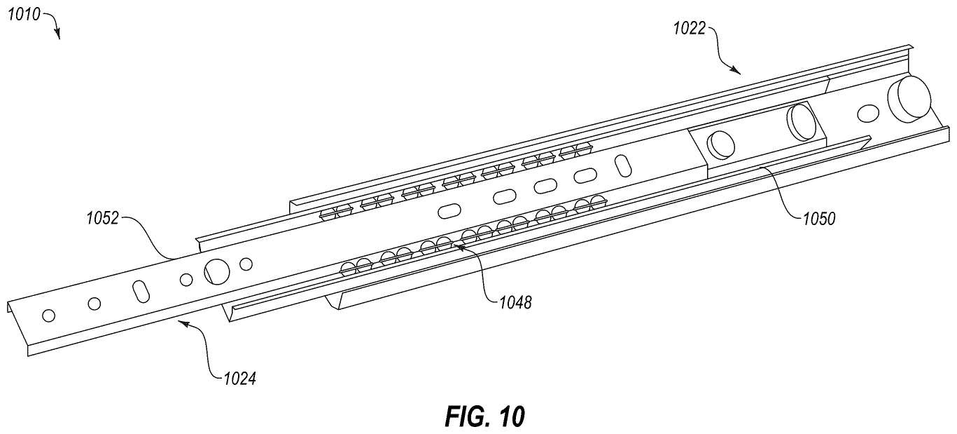

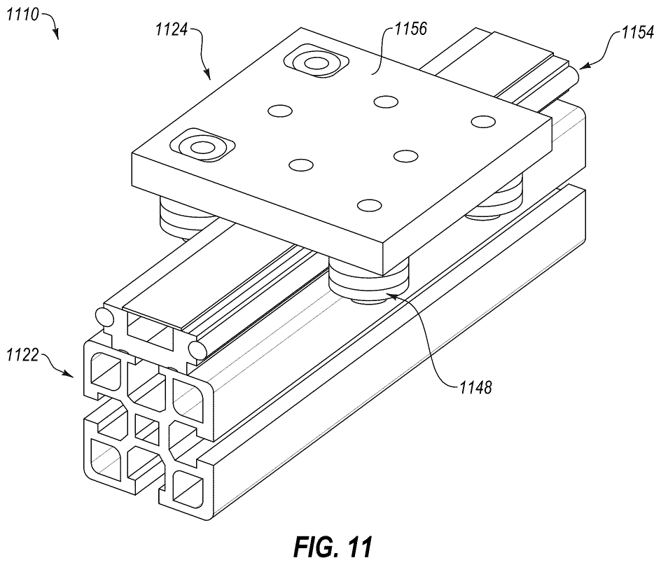

In some embodiments, the means for selectively adjusting the bracket extension relative to the mounting bracket may be a bearing positioned between the mounting bracket and the bracket extension. In an example operation, the bearing may provide a rolling interface between the mounting bracket and the bracket extension such that the bracket extension may be adjusted relative to the mounting bracket. In some embodiments, the mounting bracket may include a first guiderail, the bracket extension may include a second guiderail mated with the first guiderail, and the bearing may be positioned between the first guiderail and the second guiderail. Thus, the second guiderail may be adjusted relative to the first guiderail. In some embodiments, the mounting bracket may include a protrusion or recess, the bracket extension may include a sliding carriage, and the bearing may be configured to engage the protrusion or recess such that the bearing is positioned between the mounting bracket and the sliding carriage. As a result, the sliding carriage may be adjusted relative to the mounting bracket via the bearing. The above described embodiments are described in more detail with reference to FIGS. 10-11.

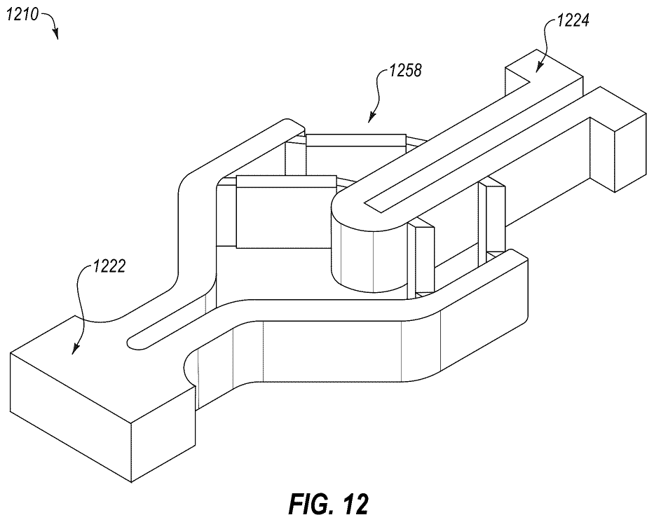

In some embodiments, the means for selectively adjusting the bracket extension may include one or more flexural joints extending from an outer surface of the bracket extension, and the one or more flexural joints may contact an inner surface of the mounting bracket. In these and other embodiments, the flexural joints may be configured to adjust the bracket extension to a first position when engaged in a first direction and to a second position when engaged in a second direction. For example, the flexural joints may adjust the bracket extension towards the mounting bracket and the center structure 106 when engaged in the first direction and away from the mounting bracket and the center structure 106 when engaged in the second direction. The above described embodiments are described in more detail with reference to FIG. 12.

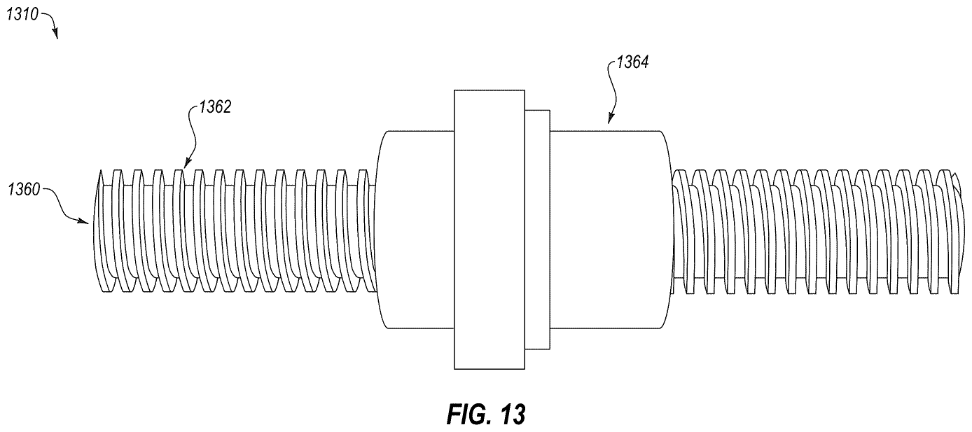

In some embodiments, the mounting bracket may further include a fastener having a set of threads, the bracket extension may include a traveler having a corresponding set of threads, and the means for selectively adjusting the bracket extension relative to the mounting bracket may be engagement of the set of threads with the corresponding set of threads. For example, the traveler may be mobilized in a first direction when the set of threads and the corresponding set of threads are threaded together in a first direction. In another example, the traveler may be mobilized in a second direction when the set of threads and the corresponding set of threads are threaded together in a second direction. The mobilization of the traveler may adjust the bracket extension relative to the mounting bracket. The above described embodiments are described in more detail with reference to FIG. 13.

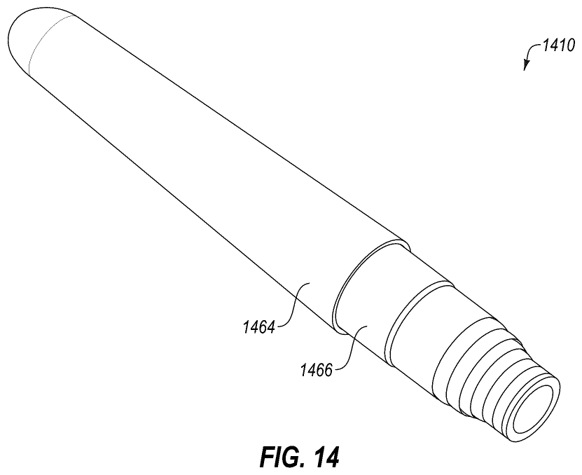

In some embodiments, the mounting bracket may include an outer tube, the bracket extension may include an inner tube disposed at least partially within the outer tube. In some embodiments, the means for selectively adjusting the bracket extension relative to the mounting bracket may be an outer diameter of the inner tube being less than an inner diameter of the outer tube. The inner tube may be adjusted by extending the inner tube from the outer tube or retracting the inner tube into the outer tube. The above described embodiments are described in more detail with reference to FIG. 14.

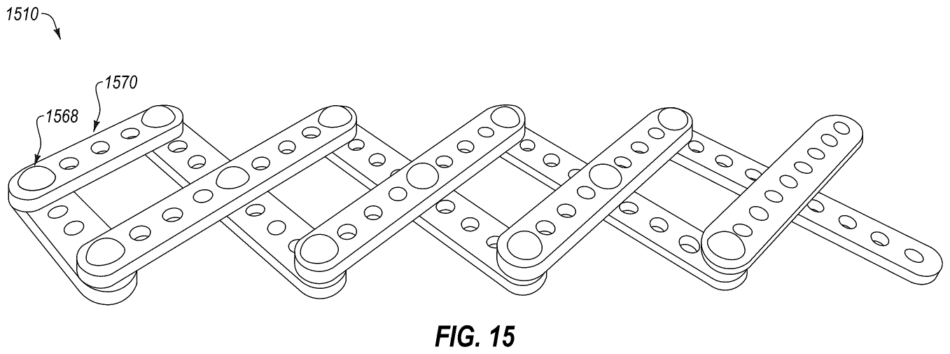

In some embodiments, the means for selectively adjusting the bracket extension relative to the mounting bracket may include a pivot joint coupling the bracket extension and the mounting bracket. In these and other embodiments, the pivot joint may allow vertical, horizontal, and/or diagonal adjustment of the bracket extension relative to the mounting bracket. For example, the pivot joint may allow the bracket extension to pivot horizontally left and right about the pivot joint, vertically up and down about the pivot joint, and/or diagonally about the pivot joint. In some embodiments, the means for selectively adjusting the bracket extension relative to the mounting bracket may further include one or more linkages coupling the bracket extension to the pivot joint. The pivot joint may be coupled to the mounting bracket and the one or more linkages may rotate about the pivot joint such that the bracket extension may be adjusted relative to the mounting bracket. The above described embodiments are described in more detail with reference to FIG. 15.

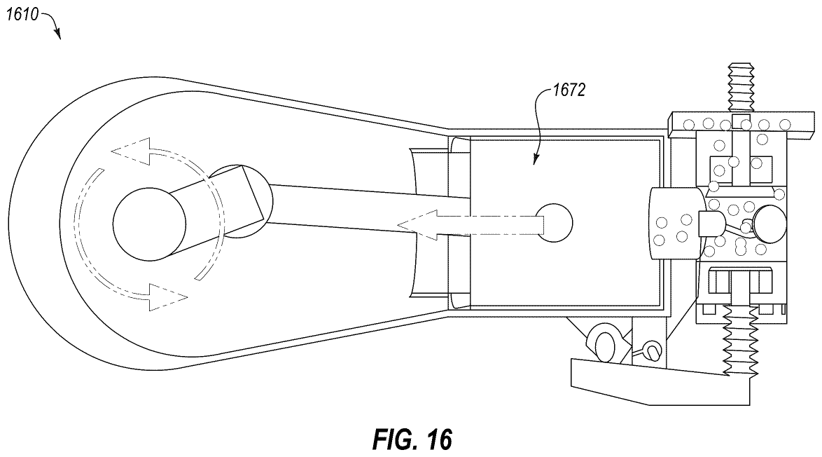

In some embodiments, the means for selectively adjusting the bracket extension may include a piston coupled to the mounting bracket and the bracket extension. The piston may adjust the bracket extension in a first direction when the piston is stroked in a first direction and may adjust the bracket extension in a second direction when the piston is stroked in a second direction. For example, on the upstroke, the piston may adjust the bracket extension towards the mounting bracket, and on the downstroke, the piston may adjust the bracket extension away from the mounting bracket. The above described embodiments are described in more detail with reference to FIG. 16.

The adjustable cable management device 110 may further include a cable retention portion (not shown) coupled to the bracket extension. The cable retention portion may be configured to be coupled to the one or more cables 108. In some embodiments, the cable retention portion may be a clamp. In some embodiments, the cable retention portion may be upwardly extending (e.g., a wall) such that the cable retention portion may prevent the one or more cables 108 from moving off the end of the bracket extension. In some embodiments, the cable retention portion may be a hook, a cable clip (e.g., a push-in clip, a U-shaped clip), a cable tie (e.g., a zip tie), a cable tray, a cable sleeve, a cable trough, a strap, or any other cable retention mechanism. In some embodiments, the cable retention portion may be coupled to a messenger line and the messenger line may be coupled to one or more cable hangers configured to receive the one or more cables 108. In some embodiments, the cable retention portion may be adjustable in size and shape such that the cable retention portion may accommodate various sizes and shapes of cables.

While the cable retention portion is described as a separate structure from the bracket extension, in some embodiments, the cable retention portion may be part of the bracket extension. For example, the cable retention portion may be integrated with the bracket extension such that the cable retention portion and the bracket extension are a single unit.

In an example operation of the adjustable cable management device 110, the adjustable cable management device 110 may be coupled to the center structure 106. For example, the mounting bracket may be coupled to the center structure 106. The bracket extension may be coupled to the mounting bracket. A cable retention portion may be coupled to the bracket extension such that one or more cables 108 may be coupled to the cable retention portion. The means for selectively adjusting the bracket extension relative to the mounting bracket may allow for vertical and/or horizontal adjustment of the bracket extension relative to the mounting bracket. For example, the bracket extension may be moved downward and away from the torque tube 104 and the PV modules 102. In another example, the bracket extension may be adjusted inwards towards the center structure 106 or outwards away from the center structure 106. Because the one or more cables 108 may be coupled to the cable retention portion, the one or more cables 108 may be adjusted simultaneously with the bracket extension of the adjustable cable management device 110 such that the cables 108 may be positioned out of the path of the moving components of the PV system 100. In some embodiments, the cables 108 may be removed from the cable retention portion before adjusting the bracket extension

As a result, the adjustable cable management device 110 may allow for the bracket extension and, consequently, the one or more cables 108 to be repositioned relative to the mounting bracket such that the tolerances of the PV system 100 may be met. Furthermore, these components may be repositioned without having to remove and reinstall the adjustable cable management device 110 and without having to order any additional components.

Modifications, additions, or omissions may be made to the PV system 100 without departing from the scope of the present disclosure. For example, multiple PV modules 102, multiple center structures 106, and/or multiple motors 112 may be used in the PV system 100. In another example, the motor 112 and/or the gear drive mechanism 114 may be omitted. Furthermore, multiple adjustable cable management devices 110 may be utilized in the PV system 100. For example, an adjustable cable management device 110 may be coupled to each center structure 106 in the PV system 100.

Furthermore, the components illustrated in FIG. 1 and described with reference to FIG. 1 may be similar to, have similar features as, or perform similar functions as similarly named components described throughout this disclosure. For example, the adjustable cable management device 110 may be similar to the adjustable cable management devices described throughout this disclosure.

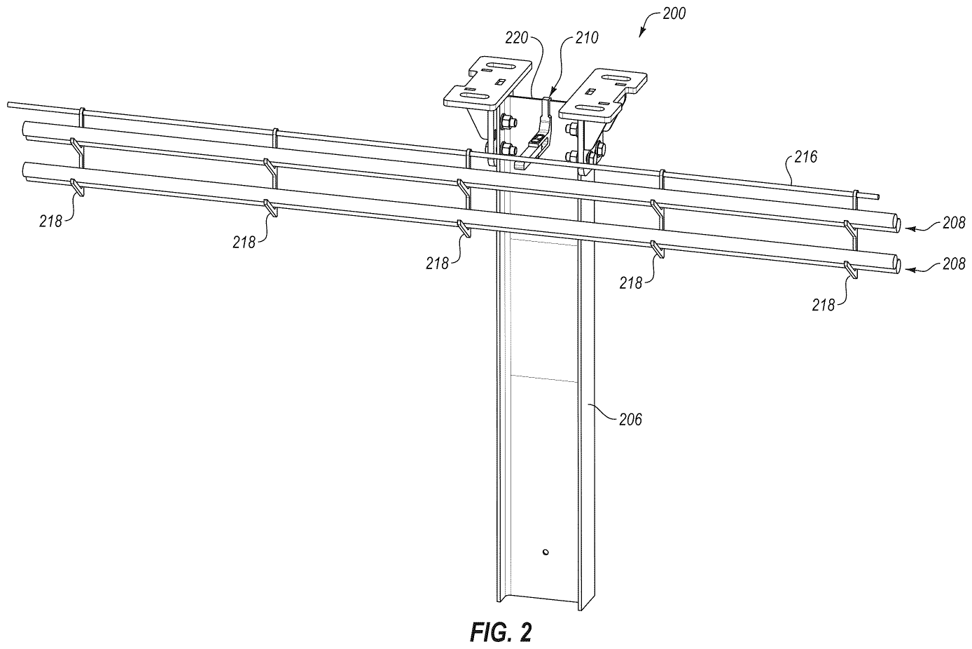

FIG. 2 is a partial view of another PV system 200 illustrating an adjustable cable management device 210 coupled to a center structure 206 of the PV system 200. The adjustable cable management device 210 may include a mounting bracket, which may couple the adjustable cable management device 210 to the center structure 206. The mounting bracket may be similar to and perform similar functions as the mounting brackets described throughout this disclosure.

The mounting bracket may further include an engaging portion that is configured to engage a receiving portion 220 of the center structure 206. As illustrated in FIG. 2, the engaging portion is a hook that engages an edge of the center structure 206, which may be the receiving portion 220. For example, the hook may define a space that a top edge of the center structure 206 may be configured to fit within. In some embodiments, the engaging portion may be a hanger, a clip, a fastener, a protrusion, or any other engagement mechanism that may couple the mounting bracket to the center structure 206. In some embodiments, the receiving portion 220 may be an aperture (e.g., a hole or a slot), a recess, a channel, a groove, or any other receiving mechanism that may receive the engaging portion of the mounting bracket.

The adjustable cable management device 210 may further include a bracket extension coupled to the mounting bracket and a means for selectively adjusting the bracket extension relative to the mounting bracket. The bracket extension may be similar to and perform similar functions as the bracket extension described throughout this disclosure, and the means for selectively adjusting the bracket extension relative to the mounting bracket may be any of the means described throughout this disclosure.

The adjustable cable management device 210 may further include a cable retention portion coupled to the bracket extension. The cable retention portion may be similar to and perform similar functions as the cable retention portions described throughout this disclosure. For example, the cable retention portion may be coupled to one or more cables 208. In some embodiments, the cable retention portion may be adjustable in size and shape such that the cable retention portion may accommodate various sizes and shapes of cables.

In some embodiments, the cable retention portion may be coupled to a messenger line 216, and the messenger line 216 may be coupled to one or more cable hangers 218 that may receive the one or more cables 208. The messenger line 216 may provide structural support for the one or more cable hangers 218 and the one or more cables 208 that may be coupled to the one or more cable hangers 218. The messenger line 216 may run between center structures 206 in the PV system 200. The cable hangers 218 may include one or more portions that are capable of receiving the one or more cables 208. For example, as illustrated in FIG. 2, the cable hangers 218 may include an upper portion (e.g., a first hook) that may receive an upper set of cables 208 and a lower portion (e.g., a second hook) that may receive a lower set of cables 208.

In some embodiments, the cable hangers 218 may be distributed at equivalent intervals along the length of the messenger line 216. In some embodiments, the cable hangers 218 may be distributed at varying intervals along the length of the messenger line 216.

In an example operation, the bracket extension of the adjustable cable management device 210 may be selectively adjusted relative to the mounting bracket. The adjustment of the bracket extension may cause the cable retention portion to be adjusted, which may in turn cause the messenger line 216 and the cable hangers 218 to be adjusted. As a result, the cables 208 may be adjusted and repositioned in the PV system 200.

Modifications, additions, or omissions may be made to the PV system 200 without departing from the scope of the present disclosure. For example, the messenger line 216 may be omitted and a cable hanger 218 may be coupled directly to the adjustable cable management device 210. In some instances, the cable hanger 218 may be the cable retention portion. In addition, a greater or lesser number of cable hangers 218 may be utilized in the PV system 200 depending on the particular configuration. For example, the cable retention portion may be coupled to the one or more cables 208 without utilizing the messenger line 216 and/or the cable hangers 218.

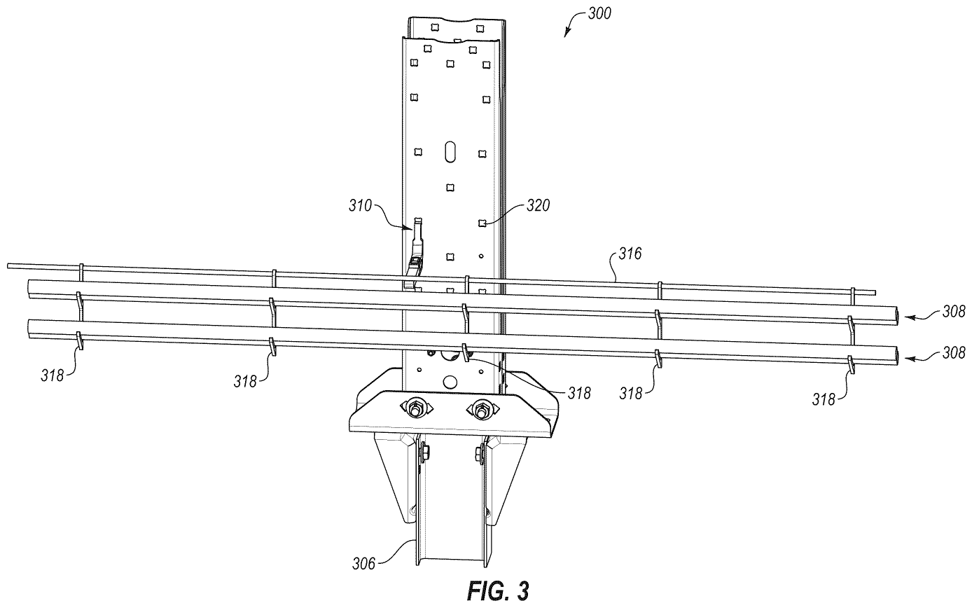

Additionally, the adjustable cable management device 210 may be coupled to the center structure 206 in a different manner than that illustrated with respect to FIG. 2. For example, FIG. 3 illustrates a PV system 300 with a center structure 306 having one or more receiving portions 320. As illustrated in FIG. 3, the receiving portions 320 may be apertures (e.g., slots) in the center structure 306 that may be engaged by an engaging portion included in a mounting bracket of an adjustable cable management device 310. The engaging portion may be a hook, and the receiving portions 320 may be slots configured to receive the hook.

In an example operation, the one or more receiving portions 320 may allow the adjustable cable management device 310 to be adjusted relative to the center structure 306. For example, the adjustable cable management device 310 may be moved vertically or horizontally into any of the respective receiving portions 320 illustrated in FIG. 3.

The components illustrated in FIGS. 2 and 3 and described with reference to FIGS. 2 and 3 may be similar to, have similar features as, or perform similar functions as similarly named components described throughout this disclosure. For example, the adjustable cable management devices 210 and 310 may be similar to the adjustable cable management devices described throughout this disclosure.

FIGS. 4A and 4B respectively illustrate a perspective view and an exploded view of an adjustable cable management device 410. The adjustable cable management device 410 includes a mounting bracket 422 and a bracket extension 424 coupled to the mounting bracket 422. A cable retention portion 426 is coupled to the bracket extension 424 and is configured to be coupled to one or more cables (not shown).

The mounting bracket 422 is configured to be coupled to the center structure of a PV system (e.g., the center structures 106, 206, or 306 of FIGS. 1-3). For example, the mounting bracket 422 may include an engaging portion 434 configured to engage a receiving portion of the center structure. As illustrated in FIGS. 4A and 4B, the engaging portion 434 is a hook that may engage a receiving portion (e.g., the receiving portions 220 or 320 of FIGS. 2-3). In some embodiments, the engaging portion 434 may be a hanger, a clip, a fastener, a protrusion, or any other engagement mechanism that may couple the mounting bracket 422 to the center structure. In some embodiments, the receiving portion may be an aperture (e.g., a slot), a recess, a channel, a groove, or any other receiving mechanism that may receive the engaging portion 434 of the mounting bracket 422.

The mounting bracket 422 may include one or more apertures 428. The one or more apertures 428 may have a geometric shape (e.g., circular, square, triangular, or other geometric shapes) or a nongeometric shape. The one or more apertures 428 may be symmetric or asymmetric. In some embodiments, and as illustrated in FIGS. 4A and 4B, the one or more apertures 428 may be slots. As illustrated in FIGS. 4A and 4B, in some embodiments, the mounting bracket 422 may include a single aperture 428. As illustrated in FIGS. 4A and 4B, the aperture 428 is a through hole, but, in some embodiments, the apertures 438, may be blind holes.

The bracket extension 424 may include one or more apertures 438. In some embodiments, the bracket extension 424 may include two or more apertures 438 that may be distributed at a distance along a length of the bracket extension 424. As illustrated in FIGS. 4A and 4B, the apertures 438 are distributed at equivalent distances along the length of the bracket extension 424; however, in some embodiments, the apertures 438 may be distributed at varying distances along the length of the bracket extension 424. The one or more apertures 438 may have a geometric shape (e.g., circular, square, triangular, or other geometric shapes) or a nongeometric shape. The one or more apertures 428 may be symmetric or asymmetric. As illustrated in FIGS. 4A and 4B, the apertures 428 are through holes, but, in some embodiments, the apertures 438, may be blind holes.

In some embodiments, the bracket extension 424 may include a stop 436. The stop 436 may be located at an opposite end of the bracket extension 424 as the cable retention portion 426. For example, as illustrated in FIG. 4A, the cable retention portion 426 may be coupled to the bracket extension 424 at a distal end of the bracket extension 424, and the stop 436 may be located at a proximal end (e.g., closer to the mounting bracket 422) of the bracket extension 424. The stop 436 may be sized and configured to fit within the one or more apertures 428 of the mounting bracket 422. The stop 436 may be configured to limit the adjustment of the bracket extension 424 relative to the mounting bracket 422. For example, the stop 436 may contact a proximal end of the aperture 428, which may be a slot, when the bracket extension 424 is adjusted to a limit in the direction towards the mounting bracket 422 and towards the center structure. Furthermore, the stop 436 may align the bracket extension 424 with the mounting bracket 422 when the stop 436 is positioned in the one or more apertures 428 of the mounting bracket 422. In these and other embodiments, the stop 436 may prevent the bracket extension 424 from being misaligned with the mounting bracket 422.

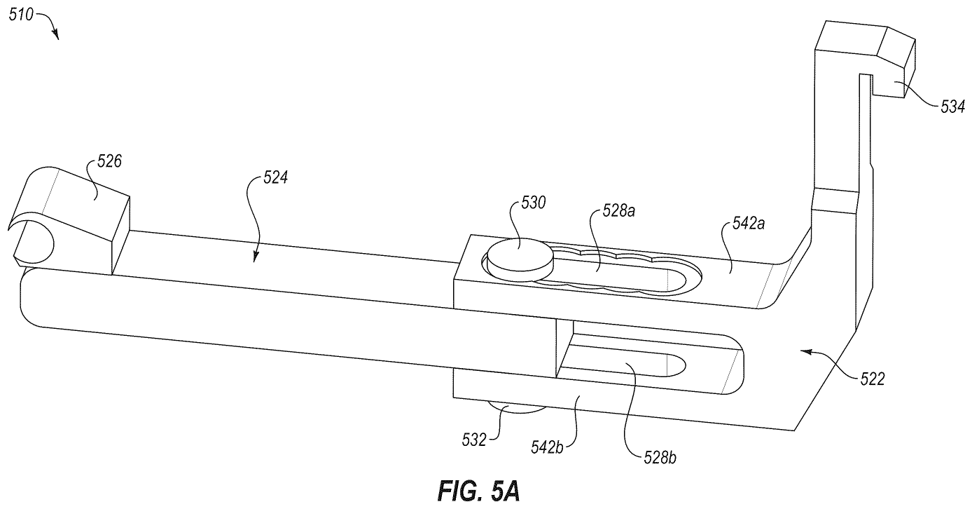

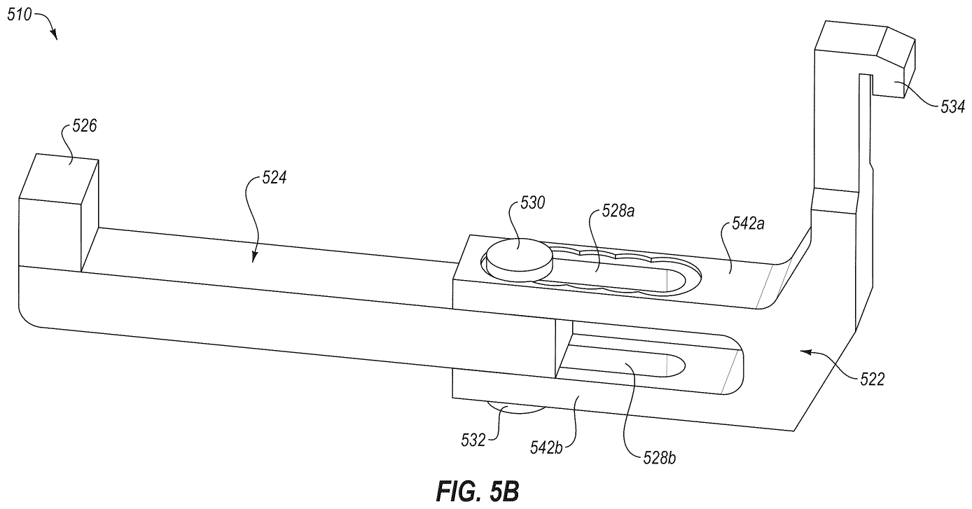

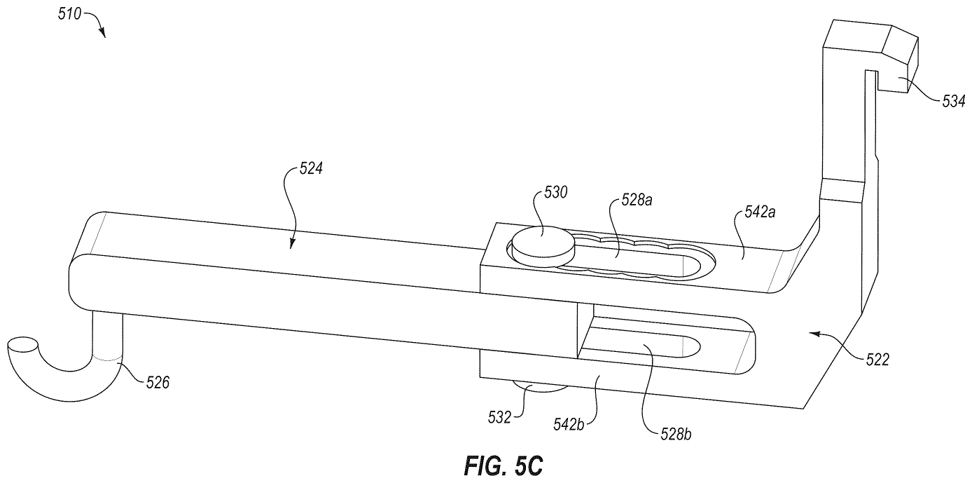

The cable retention portion 426 may be coupled to the bracket extension 424 at a distal end of the bracket extension 424. The cable retention portion 426 is configured to be coupled to one or more cables. As illustrated in FIGS. 4A and 4B, the cable retention portion 426 may be a clamp. In some embodiments, and as illustrated in FIG. 5B, the cable retention portion 426 may be upwardly extending (e.g., a wall) such that the cable retention portion 426 may prevent the one or more cables from moving off the distal end of the bracket extension 424. In some embodiments, the cable retention portion 426 may be a hook (e.g., as illustrated in FIG. 5C), a cable clip (e.g., a push-in clip, a U-shaped clip), a cable tie (e.g., a zip tie), a cable tray, a cable sleeve, a cable trough, a strap, or any other cable retention mechanism. In some embodiments, the cable retention portion 426 may be coupled to a messenger line, and the messenger line may be coupled to one or more cable hangers configured to receive the one or more cables. In some embodiments, the cable retention portion 426 may be adjustable in size and shape such that the cable retention portion 426 may accommodate various sizes and shapes of cables.

While the cable retention portion 426 is illustrated as a separate structure from the bracket extension 424, in some embodiments, the cable retention portion 426 may be part of the bracket extension 424. For example, the cable retention portion 426 may be integrated with the bracket extension 424 such that the cable retention portion 426 and the bracket extension 424 are a single unit.

The adjustable cable management device 410 further includes a means for selectively adjusting the bracket extension 424 relative to the mounting bracket 422. In some embodiments, the means for selectively adjusting the bracket extension 424 relative to the mounting bracket 422 may also couple the bracket extension 424 and the mounting bracket 422. As illustrated in FIGS. 4A and 4B, the means for selectively adjusting the bracket extension 424 relative to the mounting bracket 422 may be a first fastener 430. The first fastener 430 may be a bolt, a screw, a dowel, a pin, a rod, a shaft, a rivet, or any other suitable fastener. In some embodiments, the first fastener 430 may be secured by a second fastener 432. The second fastener 432 may be a nut (e.g., a hex nut as illustrated in FIGS. 4A and 4B, a wing nut, a lock nut, or a cap nut), a pin (e.g., a cotter pin), a lock washer, a clip, a ring, a collar or any other fastener capable of retaining the first fastener 430. In these and other embodiments, as the second fastener 432 is tightened with the first fastener 430, the mounting bracket 422 and the bracket extension 424 may be further secured with one another (e.g., tightened together).

The first fastener 430 may extend through at least one of the one or more apertures 428 of the mounting bracket 422 and at least one of the one or more apertures 438 of the bracket extension 424. In these and other embodiments, the bracket extension 424 may be selectively adjustable relative to the mounting bracket 422 when the first fastener 430 is loosened, disengaged, or removed.

In an example operation, at least one of the apertures 438 of the bracket extension 424 may be at least partially aligned with the aperture 428 of the mounting bracket 422. The stop 436 may be positioned within the aperture 428 to align the mounting bracket 422 and the bracket extension 424. The first fastener 430 may be positioned such that a first end of the first fastener 430 extends through the aperture 428 and one of the apertures 438 that is at least partially aligned with the aperture 428. The second fastener 432 may be coupled and/or tightened to the first end of the first fastener 430. In this configuration, the adjustment of the bracket extension 424 relative to the mounting bracket 422 may be restricted.

When the first fastener 430 is loosened (e.g., loosened relative to the second fastener 432, the mounting bracket 422, and/or the bracket extension 424), the bracket extension 424 may be adjusted along the length of the aperture 428 even if the first fastener 430 remains within one of the apertures 438 and/or remains coupled to the second fastener 432. For example, the bracket extension 424 may be adjusted outwardly relative to the mounting bracket 422 until the first fastener 430 makes contact with the mounting bracket 422 at the distal end of the aperture 428. In another example, the bracket extension 424 may be adjusted inwardly relative to the mounting bracket 422 until the stop 436 makes contact with the mounting bracket 422 at the proximal end of the aperture 428. In embodiments where the stop 436 is not included, the orientation of the bracket extension 424 relative to the mounting bracket 422 may also be adjusted when the first fastener 430 is loosened. For example, the bracket extension 424 may be rotated about the fastener 430 when the second fastener 432 is loosened.

When the first fastener 430 is disengaged or removed, the bracket extension 424 may be adjusted relative to the mounting bracket 422 along the length of the aperture 428 (e.g., as when the first fastener 430 is loosened as described above) and/or the orientation of the bracket extension 424 may be adjusted. The bracket extension 424 is shown in FIG. 4A as being oriented in a similar direction as the mounting bracket 422, but removal of the first fastener 430 may allow the bracket extension 424 to be oriented at a different angle than the mounting bracket 422. Furthermore, in some embodiments, the stop 436 may be omitted. In these and other embodiments, the bracket extension 424 may be adjusted further inward towards the mounting bracket 422 and the center structure than the bracket extension 424 may be adjusted if the stop 436 were included.

Modifications, additions, or omissions may be made to the adjustable cable management device 410 without departing from the scope of the present disclosure. For example, as described above the stop 436 may be omitted. Furthermore, the adjustable cable management device 410 may include a greater number or lesser number of apertures 438 on the bracket extension 424 and/or of apertures 428 on the mounting bracket 422 compared to that illustrated in FIGS. 4A and 4B, depending on the configuration. In some embodiments, the second fastener 432 may be omitted. For example, the first fastener 430 may be threaded and the apertures 428 and/or the apertures 438 may have corresponding threads. In these and other embodiments, the first fastener 430 may thread into the corresponding threads to couple the mounting bracket 422 and the bracket extension 424 and/or tighten the mounting bracket 422 and the bracket extension 424 together. In addition, the first fastener 430 may thread out of the corresponding threads to decouple the mounting bracket 422 and the bracket extension 424 and/or loosen the mounting bracket 422 and the bracket extension 424 such that the bracket extension 424 may be adjusted relative to the mounting bracket 422.

The components illustrated in FIGS. 4A and 4B and described with reference to FIGS. 4A and 4B may be similar to, have similar features as, or perform similar functions as similarly named components described throughout this disclosure. For example, the mounting bracket 422, the bracket extension 424, the cable retention portion 426, and/or the means for selectively adjusting the bracket extension 424 relative to the mounting bracket 422 may be similar to and perform similar functions as similar features described throughout this disclosure. For instance, the adjustable cable management device 410 may utilize the mounting brackets, the bracket extensions, the cable retention portions, and/or the means for selectively adjusting the bracket extension relative to the mounting bracket described with respect to other Figures in this disclosure.

FIG. 5A is a perspective view of another adjustable cable management device 510. The adjustable cable management device 510 includes a mounting bracket 522 and a bracket extension 524 coupled to the mounting bracket 522. The adjustable cable management device 510 further includes a cable retention portion 526 coupled to the bracket extension 524.

The mounting bracket 522 is configured to be coupled to the center structure of a PV system (e.g., the center structures 106, 206, or 306 of FIGS. 1-3). For example, the mounting bracket 522 may include an engaging portion 534 configured to engage a receiving portion of the center structure. The engaging portion 534 and the receiving portion may be similar to and perform similar functions to the engaging portions and the receiving portions described throughout this disclosure.

The mounting bracket 522 may include a first arm 542a and a second arm 542b (collectively, the arms 542). As illustrated in FIG. 5A, the first arm 542a may be aligned with and positioned above the second arm 542b such that a space is defined between the first arm 542a and the second arm 542b. The space between the first arm 542a and the second arm 542b may be sized and configured to receive the bracket extension 524 such that the bracket extension 524 may be positioned between the first arm 542a and the second arm 542b. In these and other embodiments, the bracket extension 524 may be adjusted horizontally (e.g., inwardly, outwardly, and side-to-side) but the arms 542 may limit the vertical adjustment of the bracket extension 524.

In some embodiments, the first arm 542a and the second arm 542b may be configured in a different manner than that shown in FIG. 5A. For example, the first arm 542a and the second arm 542b may be aligned horizontally such that neither arm 542 is positioned above the other. In these and other embodiments, a space sized and configured to receive the bracket extension 524 may be defined between the first arm 542a and the second arm 542b. Furthermore, in these and other embodiments, the bracket extension 524 may be adjusted inwardly, outwardly, and vertically but the arms 542 may limit the side-to-side adjustment of the bracket extension 524.

The first arm 542a may have a first aperture 528a and the second arm 542b may have a second aperture 528b (collectively, the apertures 528). The apertures 528 may have a geometric shape (e.g., circular, square, triangular, or other geometric shapes) or a nongeometric shape. The apertures 528 may be symmetric or asymmetric. As illustrated in FIG. 5A, the first aperture 528a and the second aperture 528b may be slots.

The bracket extension 524 may include one or more apertures (not shown). In some embodiments, the bracket extension 524 may include at least two apertures distributed at a distance along a length of the bracket extension 524 (e.g., similar to the bracket extension 424 described with respect to FIGS. 4A-4B). The one or more apertures of the bracket extension 524 may have a geometric shape (e.g., circular, square, triangular, or other geometric shapes) or a nongeometric shape. The one or more apertures of the bracket extension 524 may be symmetric or asymmetric.

As previously described, the bracket extension 524 may be positioned between the first arm 542a and the second arm 542b. The bracket extension 524 may be positioned such that an aperture of the bracket extension 524 aligns with the at least a portion of the first aperture 528a and at least a portion of the second aperture 528b such that the bracket extension 524 and the mounting bracket 522 may be coupled together via a first fastener 530. In some embodiments and as illustrated in FIG. 5A, the bracket extension 524 may be positioned such that the first arm 542a, the second arm 542b, and the bracket extension 524 extend outwards in the same direction relative to the center structure. In some embodiments, the bracket extension 524 may be positioned such that the bracket extension 524 extends outwards in a different direction than the first arm 542a and the second arm 542b relative to the center structure (e.g., the bracket extension 524 may be angular relative to the arms 542).

The adjustable cable management device 510 further includes a means for selectively adjusting the bracket extension 524 relative to the mounting bracket 522. As illustrated, in FIG. 5A, the means includes the first fastener 530. The first fastener 530 may extend through the first aperture 528a, through an aperture of the bracket extension 524, and through the second aperture 528b such that the mounting bracket 522 and the bracket extension 524 are coupled at the first arm 542a and the second arm 542b of the mounting bracket 522. In some embodiments, the first fastener 530 may be secured to a second fastener 532. In these and other embodiments, as the second fastener 532 is tightened with the first fastener 530, the first arm 542a and/or the second arm 542b may be tightened against the bracket extension 524.

The cable retention portion 526 is configured to be coupled to one or more cables. As illustrated in FIG. 5A, the cable retention portion 526 may be a clamp. In these and other embodiments, the cable retention portion 526 may be adjustable in size and shape such that the cable retention portion 526 may be coupled to various sizes and shapes of cables in a PV system. In some embodiments, the cable retention portion 526 may be coupled to a messenger line (e.g., the messenger line 216 and 316 of FIGS. 2 and 3), and one or more cable hangers configured to receive one or more cables may be coupled to the messenger line.

In an example operation, the first aperture 528a, the second aperture 528b, and an aperture of the bracket extension 524 may be at least partially aligned. The first fastener 530 may be positioned such that a first end of the first fastener 530 extends through the first aperture 528a, through an aperture of the bracket extension 524, and through the second aperture 528b. The second fastener 532 may be coupled and/or tightened to the first end of the first fastener 530. As the first fastener 530 and the second fastener 532 are tightened together, the first arm 542a and the second arm 542b may be tightened against the bracket extension 524. In this configuration, the adjustment of the bracket extension 524 relative to the mounting bracket 522 may be restricted.

The first fastener 530 may allow the bracket extension 524 to be selectively adjusted relative to the mounting bracket 522 when the first fastener 530 is loosened, disengaged, or removed. For example, when the first fastener 530 is loosened, the coupling between the mounting bracket 522 and the bracket extension 524 may be maintained, but the bracket extension 524 may be selectively adjusted by sliding the bracket extension 524 along the first aperture 528a and the second aperture 528b inwards towards the mounting bracket 522 or outwards away from the mounting bracket 522 and/or by adjusting the orientation of the bracket extension 524 relative to the mounting bracket 522. In another example, the first fastener 530 may be disengaged or removed, and the bracket extension 524 may be repositioned relative to the mounting bracket 522. For instance, disengaging or removing the first fastener 530 may allow the bracket extension 524 to be selectively adjusted in the same manner as loosening the first fastener 530.

As the bracket extension 524 is adjusted, the position of the cable retention portion 526 and thereby the cables coupled to the cable retention portion 526 may also be adjusted. Thus, the adjustable cable management device 510 may allow the cables to be repositioned in a PV system without having to remove and reinstall the adjustable cable management device 510 and/or without having to order a different sized mounting bracket and/or bracket extension.

Modifications, additions, or omissions may be made to the adjustable cable management device 510 without departing from the scope of the present disclosure. For example, the mounting bracket 522 may have a greater or lesser number of arms 542 depending on the configuration and/or each arm 542 may have more than one aperture 528. Furthermore, the bracket extension 524 may have more than one aperture (e.g., similar to the bracket extension 424 described with reference to FIGS. 4A and 4B). In some embodiments, the second fastener 532 may be omitted. For example, the first fastener 530 may be threaded and the apertures 528 and/or the apertures of the bracket extension 524 may have corresponding threads. In these and other embodiments, the first fastener 530 may thread into the corresponding threads to couple the mounting bracket 522 and the bracket extension 524 and/or tighten the mounting bracket 522 and the bracket extension 524 together. In addition, the first fastener 530 may thread out of the corresponding threads to decouple the mounting bracket 522 and the bracket extension 524 and/or loosen the mounting bracket 522 and the bracket extension 524 such that the bracket extension 524 may be adjusted relative to the mounting bracket 522.

Furthermore, the cable retention portion 526 may be configured in a different manner than as a clamp. For example, FIG. 5B illustrates the adjustable cable management device 510 having a cable retention portion 526 that is an upwardly extending wall. In these and other embodiments, the cables may be placed on top of the bracket extension 524, and the cable retention portion 526 may prevent the one or more cables from moving off the distal end of the bracket extension 524. In some embodiments, a messenger line may be placed on top of the bracket extension 524 and one or more cable hangers may be coupled to the messenger line. In some embodiments, the cable retention portion 526 may be detachable from the bracket extension 524 such that different cable retention portions 526 (e.g., different styles, sizes, or configurations) may be installed, depending on the configuration of the PV system.

In another example, FIG. 5C illustrates the adjustable cable management device 510 having a cable retention portion 526 that is a hook. The hook may be sized and configured to receive one or more cables. In some embodiments, the hook may be sized and configured to be coupled to a messenger line, and one or more cable hangers may be coupled to the messenger line. In some embodiments, the adjustable cable management device 510 may utilize multiple cable retention portions 526. For example, the adjustable cable management device 510 may include a first cable retention portion that may be an upwardly extending wall (e.g., such as that illustrated in FIG. 5B) and a second cable retention portion that may be a hook (e.g., such as that illustrated in FIG. 5C).

The cable retention portion 526 may also be configured in different ways other than the cable retention portions 526 illustrated in FIGS. 5A-5C. For example, the cable retention portion 526 may be a cable clip (e.g., a push-in clip, a U-shaped clip), a cable tie (e.g., a zip tie), a cable tray, a cable sleeve, a cable trough, a strap, or any other cable retention mechanism. In these and other embodiments, the cable retention portion 526 may be adjustable in size and shape such that the cable retention portion 526 may accommodate various sizes and shapes of cables.

The components illustrated in FIGS. 5A-5C and described with reference to FIG. 5A-5C may be similar to, have similar features as, or perform similar functions as similarly named components described throughout this disclosure. For example, the mounting bracket 522, the bracket extension 524, the cable retention portion 526, and/or the means for selectively adjusting the bracket extension 524 relative to the mounting bracket 522 may be similar to and perform similar functions as similar features described throughout this disclosure. For instance, the adjustable cable management device 510 may utilize the mounting brackets, the bracket extensions, the cable retention portions, and/or the means for selectively adjusting the bracket extension relative to the mounting bracket described with respect to other Figures in this disclosure.

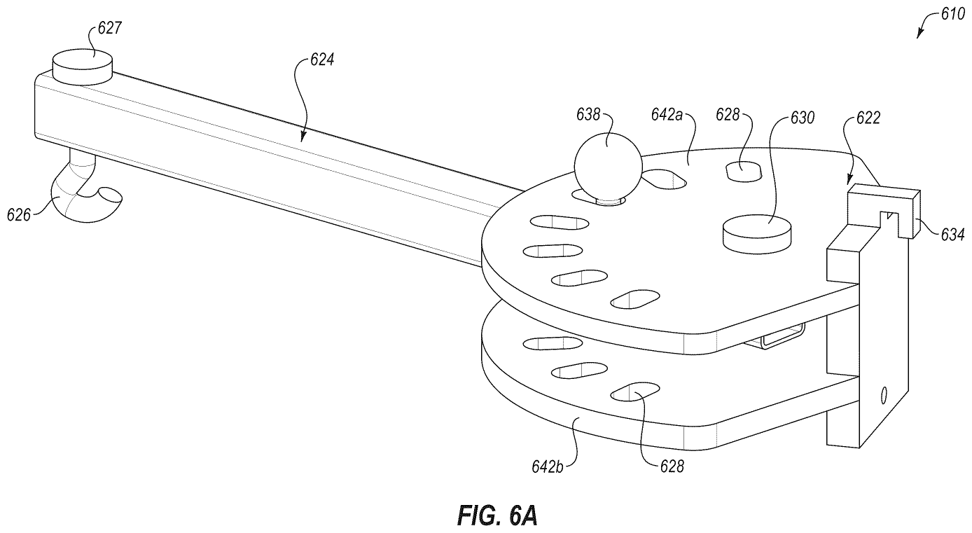

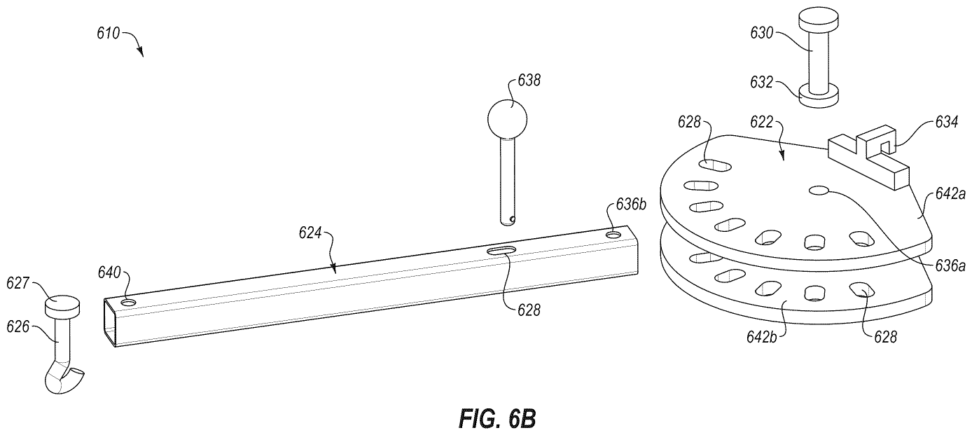

FIGS. 6A and 6B respectively illustrate a perspective view and an exploded view of an adjustable cable management device 610. The adjustable cable management device 610 includes a mounting bracket 622 and a bracket extension 624 coupled to the mounting bracket 622. A cable retention portion 626 is coupled to the bracket extension 624 and is configured to be coupled to one or more cables (not shown).

The mounting bracket 622 is configured to be coupled to the center structure of a PV system (e.g., the center structures 106, 206, or 306 of FIGS. 1-3). For example, the mounting bracket 622 may include an engaging portion 634 configured to engage a receiving portion of the center structure. As illustrated in FIGS. 6A and 6B, the engaging portion 634 is a hook that may engage a receiving portion of the center structure (e.g., the receiving portions 220 or 320 of FIGS. 2-3).

The mounting bracket 622 may include a first arm 642a and a second arm 642b (collectively, the arms 642). As illustrated in FIG. 6A, the first arm 642a may be aligned with and positioned above the second arm 642b such that a space is defined between the first arm 642a and the second arm 642b. The space between the first arm 642a and the second arm 642b may be sized and configured to receive the bracket extension 624 such that the bracket extension 624 may be positioned between the first arm 642a and the second arm 642b. In these and other embodiments, the bracket extension 624 may be adjusted horizontally (e.g., inwardly, outwardly, and side-to-side) but the arms 642 may limit the vertical adjustment of the bracket extension 624.

In some embodiments, the first arm 642a and the second arm 642b may be configured in a different manner than that shown in FIG. 6A. For example, the first arm 642a and the second arm 642b may be aligned horizontally such that neither arm 642 is positioned above the other. In these and other embodiments, a space sized and configured to receive the bracket extension 624 may be defined between the first arm 642a and the second arm 642b. Furthermore, in these and other embodiments, the bracket extension 624 may be adjusted inwardly, outwardly, and vertically but the arms 642 may limit the side-to-side adjustment of the bracket extension 624.

In some embodiments, the bracket extension 624 may be coupled to the mounting bracket 622 via a pivot joint 630. The pivot joint 630 may extend through a first pivot joint aperture 636a in the first arm 642a, a second pivot joint aperture 636b at a proximal end of the bracket extension 624, and a third pivot joint aperture (not shown) in the second arm 642b (collectively, the pivot joint apertures 636). The pivot joint apertures 636 may have a geometric shape (e.g., circular, square, triangular, or other geometric shapes) or a nongeometric shape. The pivot joint apertures 636 may be symmetric or asymmetric.

The pivot joint 630 may enable the bracket extension 624 to be rotated about the pivot joint 630. For example, the bracket extension 624 may be rotated in a clockwise direction or a counterclockwise direction about the pivot joint 630. In some embodiments, the pivot joint 630 may be a pin, a hinge, a ball-joint, or any other suitable joint allowing for rotational or multi-directional movement of the bracket extension 624. In some embodiments, the pivot joint 630 may be secured to a first fastener 632. The first fastener 632 may be a nut (e.g., a hex nut, a wing nut, a lock nut, or a cap nut), a pin (e.g., a cotter pin), a lock washer, a clip, a ring, a collar or any other fastener capable of retaining the pivot joint 630.

The first arm 642a and the second arm 642b of the mounting bracket 622 may include one or more adjustment apertures 628. For example, as illustrated in FIGS. 6A and 6B, the first arm 642a and the second arm 642b may each include multiple adjustment apertures 628. The bracket extension 624 may also include one or more adjustment apertures 628. In some embodiments, the bracket extension 624 may include multiple adjustment apertures 628. For example, the bracket extension 624 may include at least two apertures distributed at a distance along a length of the bracket extension 624 (e.g., similar to the bracket extension 424 described with respect to FIGS. 4A and 4B). The adjustment apertures 628 may have a geometric shape (e.g., circular, square, triangular, or other geometric shapes) or a nongeometric shape. The adjustment apertures 628 may be symmetric or asymmetric. In some embodiments, the adjustment apertures 628 may be slots.

In some embodiments, the adjustment apertures 628 of the first arm 642a and the adjustment apertures 628 of the second arm 642b may be aligned. For example, and as illustrated in FIG. 6 and-6B, each adjustment aperture 628 of the first arm 642a may be aligned with a respective adjustment aperture 628 of the second arm 642b. In some embodiments, the adjustment apertures 628 of the arms 642 may be aligned with a rotational trajectory of the bracket extension 624 about the pivot joint 630. For example, as the bracket extension 624 rotates about the pivot joint 630, an adjustment aperture 628 of the bracket extension 624 may have a rotational trajectory about the pivot joint 630, and the adjustment apertures 628 of the arms 642 may align with the rotational trajectory of the adjustment aperture 628 of the bracket extension 624. For example, each adjustment aperture 628 of the first arm 642a may be aligned with a different point on the rotational trajectory of the adjustment aperture 628 of the bracket extension 624. In these and other embodiments, each adjustment aperture 628 of the second arm 642b may be aligned with a respective adjustment aperture 628 of the first arm 642a.

The adjustable cable management device 610 further includes a means for selectively adjusting the bracket extension 624 relative to the mounting bracket 622. In some embodiments, the means for selectively adjusting the bracket extension 624 relative to the mounting bracket 622 may be the pivot joint 630. The bracket extension 624 may be adjusted about the pivot joint 630 such that the one or more cables coupled to the cable retention portion 626 are adjusted as a result.

In some embodiments, the means for selectively adjusting the bracket extension 624 relative to the mounting bracket 622 may be a second fastener 638 that extends through one of the adjustment apertures 628 of the first arm 642a, the adjustment aperture 628 of the bracket extension 624, and one of the adjustment apertures 628 of the second arm 642b. The second fastener 638 may allow the bracket extension 624 to be selectively adjustable relative to the mounting bracket 622 when the second fastener 638 is disengaged or removed. The second fastener 638 may be a bolt, a screw, a dowel, a pin, a rod, a shaft, a rivet, or any other suitable fastener. For example, the second fastener 638 may be a spring-loaded pin that is downwardly biased such that pulling the pin may overcome a spring force exerted downwardly by the pin, and, when the pin is released, the spring force may cause the pin to move downwardly into an adjustment aperture 628 of the bracket extension 624 and/or an adjustment aperture 628 of the second arm 642b. In some embodiments, the second fastener 638 may be secured by a third fastener (not shown). The third fastener may be a nut (e.g., a hex nut, a wing nut, a lock nut, or a cap nut), a pin (e.g., a cotter pin), a lock washer, a clip, a ring, a collar or any other fastener capable of retaining the second fastener 638.

In some embodiments, and as illustrated in FIGS. 6A and 6B, the means for selectively adjusting the bracket extension 624 relative to the mounting bracket 622 may include the pivot joint 630 and the second fastener 638.

As discussed previously, the cable retention portion 626 is coupled to the bracket extension 624. For example, the cable retention portion 626 may be coupled to the bracket extension 624 via a cable retention aperture 640. As illustrated in FIGS. 6A and 6B, the cable retention portion 626 may extend through the cable retention aperture 640 and may be coupled to a fourth fastener 627. The fourth fastener 627 may be a nut, a pin, a lock washer, a clip, a ring, a collar or any other fastener capable of retaining the cable retention portion 626. The cable retention portion 626 may be similar to and function similarly to the cable retention portions described throughout this disclosure. As illustrated in FIGS. 6A and 6B, the cable retention portion 626 is a hook facing the mounting bracket 622. In some embodiments, the cable retention portion 626 may be coupled to a messenger line that may be coupled to one or more cable hangers that are configured to receive one or more cables. In some embodiments, the cable retention portion 626 may be adjustable in size and shape such that the cable retention portion 626 may be coupled to various sizes and shapes of cables in a PV system.

In an example operation, the bracket extension 624 may be positioned between the first arm 642a and the second arm 642b of the mounting bracket 622 such that the pivot joint apertures 636 are substantially aligned. The pivot joint 630 may couple the mounting bracket 622 to the bracket extension 624 and allow the bracket extension 624 to be selectively adjusted relative to the mounting bracket 622 about the pivot joint 630. The second fastener 638 may extend through an adjustment aperture 628 of the first arm 642a, an adjustment aperture 628 of the bracket extension 624, and an adjustment aperture 628 of the second arm 642b. To adjust the bracket extension 624, the second fastener 638 may be disengaged or removed from the adjustment apertures 628, allowing the bracket extension 624 to be rotated about the pivot joint 630 to a desired orientation. The adjustment of the bracket extension 624 may be maintained by inserting the second fastener 638 through an adjustment aperture 628 of the first arm 642a at the desired orientation, the adjustment aperture 628 of the bracket extension 624, and an adjustment aperture 628 of the second arm 642b at the desired orientation.

As the bracket extension 624 is adjusted, the cable retention portion 626 and thereby the cables coupled to the cable retention portion 626 may also be adjusted. Thus, the adjustable cable management device 610 may allow the cables to be repositioned in a PV system without having to remove and reinstall the adjustable cable management device 610 and/or without having to order a different sized mounting bracket and/or bracket extension.

Modifications, additions, or omissions may be made to the adjustable cable management device 610 without departing from the scope of the present disclosure. For example, the adjustable cable management device 610 may include a greater number or lesser number of adjustment apertures 628, pivot joint apertures 636, and/or cable retention apertures 640 depending on the configuration. Furthermore, as illustrated the first arm 642a is positioned above the second arm 642b, such that the bracket extension 624 may be rotated horizontally about the pivot joint 630, but in some embodiments, the first arm 642a and the second arm 642b may be positioned to the side of one another or at an angle relative to one another such that the bracket extension 624 may be rotated vertically about the pivot joint 630 or diagonally about the pivot joint 630.

In some embodiments, the pivot joint apertures 636 may be omitted, the pivot joint 630 may be positioned between the first arm 642a and the second arm 642b, and the bracket extension 624 may be coupled to the pivot joint 630 at a proximal end of the bracket extension 624. In some embodiments, the second fastener 638 may be omitted. In these and other embodiments, the adjustment apertures 628 may be omitted.

In some embodiments, the cable retention aperture 640 may be omitted and the cable retention portion 626 may be integrated with the bracket extension 624 such that the cable retention portion 626 and the bracket extension 624 form a single unit. In some embodiments, the first fastener 632 and the fourth fastener 627 may be omitted.

Furthermore, the components illustrated in FIGS. 6A and 6B and described with reference to FIGS. 6A and 6B may be similar to, have similar features as, or perform similar functions as similarly named components described throughout this disclosure. For example, the mounting bracket 622, the bracket extension 624, the cable retention portion 626, and/or the means for selectively adjusting the bracket extension 624 relative to the mounting bracket 622 may be similar to and perform similar functions as similar features described throughout this disclosure. For instance, the adjustable cable management device 610 may utilize the mounting brackets, the bracket extensions, the cable retention portions, and/or the means for selectively adjusting the bracket extension relative to the mounting bracket described with respect to other Figures in this disclosure.

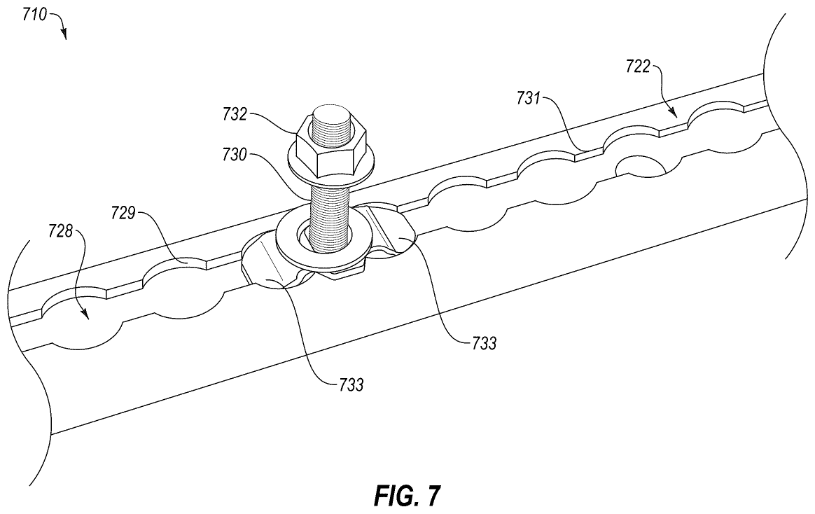

FIGS. 7-16 illustrate portions of adjustable cable management devices including various means for selectively adjusting a bracket extension relative to a mounting bracket in an adjustable cable management device. The means for selectively adjusting the bracket extension relative to the mounting bracket illustrated in FIGS. 7-16 may be utilized in the PV systems 100, 200, 300 of FIGS. 1-3 and/or the adjustable cable management devices 410, 510 or 610 of FIGS. 4A and 4B, FIGS. 5A-5C, and FIGS. 6A-6C.

FIG. 7 illustrates a portion of an adjustable cable management device 710 including a mounting bracket 722. The mounting bracket 722 may be coupled to a bracket extension (not shown), and the bracket extension may be selectively adjustable relative to the mounting bracket 722. A cable retention portion (not shown) may be configured to be coupled to one or more cables, and may be coupled to the bracket extension such that adjustment of the bracket extension may adjust the cable retention portion and thereby the cables. A means for selectively adjusting the bracket extension relative to the mounting bracket 722 may be a fastener 730 that extends through an aperture 728 in the mounting bracket 722 and through an aperture (not shown) in the bracket extension. Thus, the fastener 730 may couple the mounting bracket 722 to the bracket extension.

The fastener 730 and the aperture 728 of the mounting bracket 722 may be shaped and configured such that the fastener 730 may be inserted in the aperture 728 and adjusted along the length of the aperture 728. For example, the aperture 728 may be a slot, which the fastener 730 may be adjusted along. The adjustment of the fastener 730 may adjust the bracket extension relative to the mounting bracket 722. The aperture 728 may be defined by the mounting bracket 722 such that the aperture 728 includes one or more release points 729 and one or more engagement points 731. The aperture 728 may have a greater width at the release points 729 than the aperture 728 does at the engagement points 731. The release points 729 may allow the fastener 730 to be removed from the aperture 728, and the engagement points 731 may prevent the fastener 730 from being removed from the aperture 728. For example, the fastener 730 may be a double lug stud, and the aperture 728 may allow the fastener 730 to be removed from the aperture when each of the lugs 733 align with a release point 729 because the release points 729 may be wider than the lugs 733. On the other hand, the lugs 733 may be wider than the engagement points 731 such that the fastener 730 may not be removed from the aperture 728 when the lugs 733 are aligned with engagement points 731. Although the fastener 730 is described as a double-lug stud, it will be appreciated that other fasteners may be used that may be removed from the aperture 728 when aligned with one or more of the release points 729, and that may not be removed from the aperture 728 when aligned with one or more of the engagement points 731.

In some embodiments, the fastener 730 may be secured in the aperture 728 by a second fastener 732. The second fastener 732 may be a nut (e.g., a hex nut, a wing nut, a lock nut, or a cap nut), a pin (e.g., a cotter pin), a lock washer, a clip, a ring, a collar or any other fastener capable of retaining the fastener 730 in the aperture 728. In these and other embodiments, as the second fastener 732 is tightened with the fastener 730, the mounting bracket 722 and the bracket extension may be further secured with one another (e.g., tightened together). As a result, the second fastener 732 may restrict the movement of the fastener 730 along the aperture 728.

In an example operation, the bracket extension may be selectively adjusted relative to the mounting bracket 722 via the fastener 730, the fastener 730 may be removed from the aperture 728 by aligning the fastener 730 with one or more release points 729, and the fastener 730 may be inserted into a different release point 729 at a different location along the aperture 728. Because the bracket extension may be coupled with the fastener 730, the bracket extension may be adjusted along with the fastener 730. In another example, the fastener 730 may be loosened by loosening the second fastener 732, which may allow the fastener 730 to move along the aperture 728, which may cause the bracket extension to be adjusted as well.

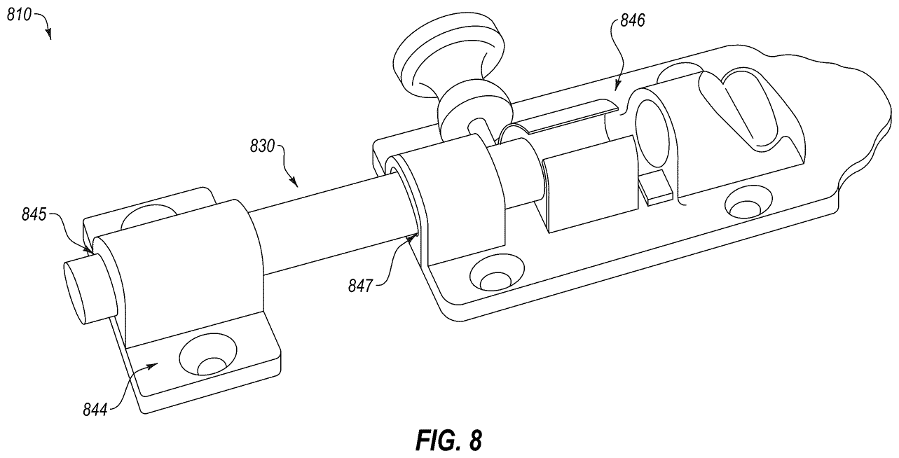

FIG. 8 illustrates a portion of an adjustable cable management device 810. The adjustable cable management device 810 may include a mounting bracket (not shown) and a bracket extension (not shown) coupled to the mounting bracket. The bracket extension may include a catch 844 and the mounting bracket may include a housing 846 for a fastener 830. The catch 844 of the bracket extension may define a first aperture 845, and the housing 846 of the bracket may define a second aperture 847. The fastener 830 may be slidably disposed within the second aperture 847 such that the fastener 830 may slide into and out of the first aperture 845 of the catch 844. In some embodiments, the bracket extension may include multiple catches 844 disposed at different locations along the bracket extension. In some embodiments, the mounting bracket may include multiple housings 846 with each housing 846 having a fastener 830 disposed within the housing 846. In some embodiments, the mounting bracket may include the catche(s) 844 and the bracket extension may include the housing(s) 846.

The adjustable cable management device 810 includes a means for selectively adjusting a bracket extension relative to the mounting bracket. As illustrated in FIG. 8, the means may be the fastener 830. In an example operation, the fastener 830 may be removed from the catch 844 by sliding the fastener 830 out of the first aperture 845 and further into the second aperture 847 of the housing 846. The bracket extension may be adjusted relative to the mounting bracket, which may also cause a cable retention portion coupled to the bracket extension and one or more cables coupled to the cable retention portion to be adjusted. As discussed previously, there may be multiple catches 844 disposed along the bracket extension. Thus, the bracket extension may be adjusted to align a different catch 844 with the housing 846, and the fastener 830 may be inserted into the different catch 844 by sliding the fastener 830 into the first aperture 845 of the different catch 844. As discussed previously, in some embodiments, the mounting bracket may include multiple housings 846 with multiple fasteners 830. In these and other embodiments, the bracket extensions may be adjusted relative to the mounting bracket and the catch 844 or a different catch 844 may be aligned with the housing 846 or a different housing 846 when the bracket extension is selectively adjusted relative to the housing 846.

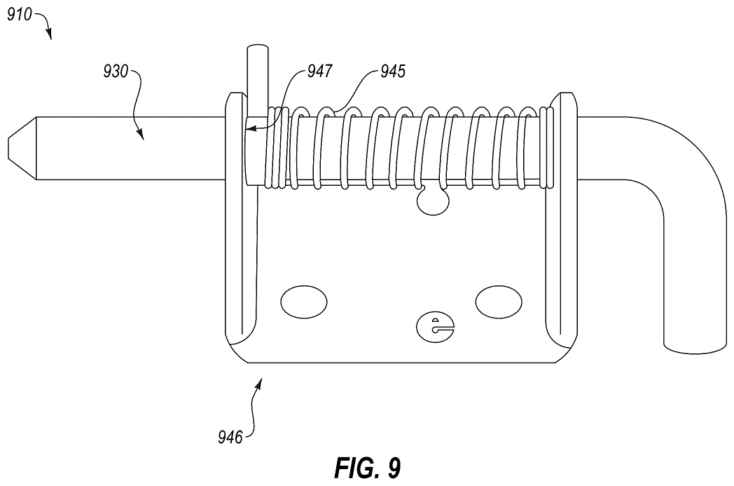

In some embodiments, the catch may be omitted. For example, FIG. 9 illustrates a portion of an adjustable cable management device 910 that includes a housing 946 for a fastener 930. The housing 946 may define a first aperture 947, and the fastener 930 may be slidably disposed within the first aperture 947. As discussed in the description to FIG. 8, the fastener 930 may be a means for selectively adjusting the bracket extension relative to the mounting bracket. In these and other embodiments, the fastener 930 may be slidably inserted into and removed from one or more apertures in the bracket extension or one or more apertures in the mounting bracket depending on where the housing(s) 946 is positioned on the adjustable cable management device 910. In some embodiments, a spring 945 may be coupled with the fastener 930. In these and other embodiments, when the a user slides the fastener 930 out of the one or more apertures in the bracket extension or the one or more apertures in the mounting bracket, the spring 945 may be compressed and provide a spring force that influences the fastener 930 to return to one of the one or more apertures in the bracket extension or the mounting bracket when the fastener 930 is released.

FIG. 10 illustrates a portion of an adjustable cable management device 1010 including a mounting bracket 1022 coupled to a bracket extension 1024. The adjustable cable management device 1010 includes a means for selectively adjusting the bracket extension 1024 relative to the mounting bracket 1022. As illustrated in FIG. 10, the means may be a bearing 1048 positioned between the mounting bracket 1022 and the bracket extension 1024.

As illustrated in FIG. 10, the mounting bracket 1022 may include a first guiderail 1050, and the bracket extension 1024 may include a second guiderail 1052 that may be mated with the first guiderail 1050. For example, as illustrated in FIG. 10, the first guiderail 1050 may be a female component configured to receive the second guiderail 1052 which may be a male component. In some embodiments, the second guiderail 1052 may be a female component configured to receive the first guiderail 1050 which may be a male component. The bearing 1048 may be positioned between the mounting bracket 1022 and the bracket extension 1024. For example, the bearing 1048 may be positioned between the first guiderail 1050 and the second guiderail 1052. In some embodiments, multiple bearings 1048 may be positioned between the first guiderail 1050 and the second guiderail 1052. In some embodiments and as illustrated in FIG. 10, bearings 1048 may be positioned in a first space defined between a first side of the first guiderail 1050 and a first side of the second guiderail 1052, and additional bearings 1048 may be positioned in a second space defined between a second side of the first guiderail 1050 and a second side of the second guiderail 1052.

In an example operation, the bearing 1048 allows for selective adjustment of the bracket extension 1024 relative to the mounting bracket 1022. The bearing 1048 may provide a rolling interface between the bracket extension 1024 and the mounting bracket 1022 such that the bracket extension 1024 may be rolled along the bearing 1048 to adjust the bracket extension 1024 relative to the mounting bracket 1022. For example, the bearing 1048 may allow the second guiderail 1052 to be extendable from and retractable into the first guiderail 1050 such that the bracket extension 1024 may be adjusted relative to the mounting bracket 1022. The adjustment of the bracket extension 1024 may also adjust a cable retention portion coupled to the bracket extension 1024 and one or more cables coupled to the cable retention portion.

FIG. 11 illustrates a portion of an adjustable cable management device 1110 including a mounting bracket 1122 coupled to a bracket extension 1124. The adjustable cable management device 1110 includes a means for selectively adjusting the bracket extension 1124 relative to the mounting bracket 1122. As illustrated in FIG. 11, the means may be a bearing 1148 positioned between the mounting bracket 1122 and the bracket extension 1124.

The mounting bracket 1122 may include a protrusion 1154 defined in the mounting bracket 1122. For example, the protrusion 1154 (e.g., rod-shaped) may be defined along an outer edge of the mounting bracket 1122. The protrusion 1154 may be configured to engage a portion of the bearing 1148 (e.g., such as a corresponding recess of the bearing) such that the bearing 1148 may be move along the protrusion 1154. In some embodiments, and as illustrated in FIG. 11, multiple bearings 1148 may be included and multiple protrusions 1154 may be included. For example, the adjustable cable management device 1110 may include four bearings 1148 and two protrusions 1154 with each protrusion 1154 being defined in opposing sides of the mounting bracket 1122 and each protrusion 1154 configured to engage at least two of the bearings 1148.

Alternatively, the mounting bracket 1122 may include recesses defined n the mounting bracket 1122 at opposite sides. In these and other embodiments, the recesses may be configured to receive a portion of the bearing 1148 such that the bearing 1148 may be partially disposed within the recess. In some embodiments, multiple bearings 1148 may be included and multiple recesses may be included. For example, the adjustable cable management device 1110 may include four bearings 1148 and two recesses with each recess being defined in opposing sides of the mounting bracket 1122 and each recess configured to engage at least two of the bearings.

The bracket extension 1124 may include a sliding carriage 1156. The sliding carriage 1156 may be coupled to the bearing 1148 such that the bearing 1148 is positioned between the mounting bracket 1122 and the sliding carriage 1156.

In an example operation, the bearing 1148 allows for selective adjustment of the bracket extension 1124 relative to the mounting bracket 1122. The bearing 1148 may provide a rolling interface between the bracket extension 1124 and the mounting bracket 1122 such that the bracket extension 1124 may be adjusted relative to the mounting bracket 1122. For example, the bearing 1148 may be coupled to the sliding carriage 1156 and may allow the sliding carriage 1156 to move along the protrusion 1154 of the mounting bracket 1122 such that the bracket extension 1124 is adjusted. The adjustment of the bracket extension 1124 may also adjust a cable retention portion coupled to the bracket extension 1124 and one or more cables coupled to the cable retention portion.

FIG. 12 illustrates a portion of an adjustable cable management device 1210 including a mounting bracket 1222 coupled to a bracket extension 1224. The adjustable cable management device 1210 includes a means for selectively adjusting the bracket extension 1224 relative to the mounting bracket 1222. As illustrated in FIG. 12, the means may include one or more flexural joints 1258 that extend from an outer surface of the bracket extension 1224 and contact an inner surface of the mounting bracket 1222.

In some embodiments, multiple flexural joints 1258 may be included. For example, as illustrated in FIG. 12, one or more flexural joints 1258 may be included on a first side of the bracket extension 1224 and one or more flexural joints 1258 may be included on a second side of the bracket extension 1224. The one or more flexural joints 1258 on the first side of the bracket extension 1224 may contact the inner surface of a first side of the mounting bracket 1222 and the one or more flexural joints 1258 on the second side of the bracket extension 1124 may contact the inner surface of a second side of the mounting bracket 1222.

The one or more flexural joints 1258 may facilitate adjustment of the bracket extension 1224 relative to the mounting bracket 1222 between a first position and a second position. For example, the one or more flexural joints 1258 may adjust the bracket extension 1224 to a first position when engaged in a first direction and a second position when engaged in a second direction.

FIG. 12 illustrates the bracket extension 1224 in an example first position in which the flexural joints 1258 are engaged with the inner surface of the mounting bracket 1222 at a first angle. In the second position, the flexural joints 1258 may be engaged with the inner surface of the mounting bracket 1222 at a second angle. In some embodiments, the second angle may be complementary to the first angle. Starting at the first position as shown in FIG. 12, a force may be applied to the bracket extension 1224 in a direction towards the mounting bracket 1222. The force may overcome the resistance between the inner surface of the mounting bracket 1222 and the flexural joints 1258, which may alter the orientation of the flexural joints 1258. For example, as illustrated in FIG. 12, the flexural joints 1258 are in a general V-shaped configuration with the flexural joints 1258 engaged in a first direction such that the vertex of the V-shape is oriented away from the mounting bracket 1222. As the force is applied inwardly towards the mounting bracket 1222, the orientation of the flexural joints 1258 may be altered such that the flexural joints 1258 may be engaged in a second direction causing the vertex of the V-shape to be oriented towards the mounting bracket 1222. This may cause the bracket extension 1224 to move inwardly to a second position.

The above described technique may also be performed in reverse. For example, from the second position, a force may be applied to the bracket extension 1224 in a direction away from the mounting bracket 1222. The force may overcome the resistance between the inner surface of the mounting bracket 1222 and the flexural joints 1258, which may alter the orientation of the flexural joints 1258 such that the flexural joints 1258 may be engaged in a first direction. This may cause the bracket extension 1224 to move outwardly back to the first position as illustrated in FIG. 12.

As a result, the bracket extension 1224 may be selectively adjusted relative to the mounting bracket 1222. The adjustment of the bracket extension 1224 may also adjust a cable retention portion coupled to the bracket extension 1224 and one or more cables coupled to the cable retention portion.

FIG. 13 illustrates a portion of an adjustable cable management device 1310. The adjustable cable management device 1310 may include a mounting bracket and a bracket extension coupled to the mounting bracket. The mounting bracket may include a fastener 1360 having a set of threads 1362. The bracket extension may include a traveler 1364 having a corresponding set of threads (not shown). The adjustable cable management device 1310 includes a means for selectively adjusting the bracket extension relative to the mounting bracket. As illustrated in FIG. 13, the means may be the engagement of the set of threads 1362 with the corresponding set of threads of the traveler 1364.

The fastener 1360 may be a threaded shaft such as a lead screw. The fastener 1360 may extend outwardly from the mounting bracket. The fastener 1360 may have any suitable shape that allows for engagement of the set of threads 1362 with the corresponding set of threads of the traveler 1364. The set of threads 1362 may include any thread type that allows the set of threads 1362 to be threaded together with the corresponding set of threads. For example, the set of threads 1362 and the corresponding set of threads may be right-hand threads, left-hand threads, unified thread standard (UTS) threads, metric threads, Acme threads, square threads, buttress threads, or any other suitable thread.

In an example operation, when the first set of threads 1362 and the corresponding set of threads are threaded together in a first direction, the traveler 1364 may be mobilized in a first direction, and, when the first set of threads 1362 and the corresponding set of threads are threaded together in a second direction, the traveler 1364 may be mobilized in a second direction. For example, the fastener 1360 may be rotated in a first direction, which may cause the first set of threads 1362 and the corresponding set of threads to be threaded together in a first direction. As a result, the traveler 1364 may be mobilized along the length of the fastener 1360 in a first direction, which may adjust the bracket extension in the first direction. The fastener 1360 may be rotated in a second direction that is opposite of the first direction, which may cause the first set of threads 1362 and the corresponding set of threads to be threaded together in a second direction. As a result, the traveler 1364 may be mobilized along the length of the fastener 1360 in a second direction, which may adjust the bracket extension in the second direction.

As a result, the bracket extension may be selectively adjusted relative to the mounting bracket. The adjustment of the bracket extension may also adjust a cable retention portion coupled to the bracket extension and one or more cables coupled to the cable retention portion.

FIG. 14 illustrates a portion of an adjustable cable management device 1410. The adjustable cable management device 1410 may include a mounting bracket and a bracket extension coupled to the mounting bracket. The mounting bracket may include an outer tube 1464. The bracket extension may include an inner tube 1466. The adjustable cable management device 1410 includes a means for selectively adjusting the bracket extension relative to the mounting bracket. As illustrated in FIG. 14, the means may be the outer diameter of the inner tube 1466 being less than the inner diameter of the outer tube 1464. In some embodiments, the bracket extension may include the outer tube 1464 and the mounting bracket may include the inner tube 1466.

Because the outer diameter of the inner tube 1466 is lesser than the inner diameter of the outer tube 1464, the inner tube 1466 may be disposed within the outer tube 1464. The inner tube 1466 may be extendable from and retractable into the outer tube 1464. For example, the inner tube 1466 may be telescopically coupled to the outer tube 1464. In some embodiments, multiple inner tubes 1466 may be telescopically coupled to the outer tube 1464. For example, a first inner tube may be disposed within the outer tube 1464, a second inner tube may be disposed within the first inner tube, a third inner tube may be disposed within the second inner tube and so on. Each of the inner tubes may be extendable from and retractable into the tube that each inner tube is disposed within.

In an example operation, a force may be applied to the inner tube 1466 and/or outer tube 1464 such that the inner tube 1466 is extended from or retracted into the outer tube 1464. As the inner tube 1466 is extended or retracted, the bracket extension may be adjusted in the same direction. For example, as the inner tube 1466 is retracted into the outer tube 1464, the bracket extension may be adjusted in the direction of retraction. In another example, as the inner tube 1466 is extended out of the outer tube 1464, the bracket extension may be adjusted in the direction of extension.

As a result, the bracket extension may be selectively adjusted relative to the mounting bracket. The adjustment of the bracket extension may also adjust a cable retention portion coupled to the bracket extension and one or more cables coupled to the cable retention portion.

FIG. 15 illustrates a portion of an adjustable cable management device 1510. The adjustable cable management device 1510 may include a mounting bracket and a bracket extension coupled to the mounting bracket. The adjustable cable management device 1510 includes a means for selectively adjusting the bracket extension relative to the mounting bracket. As illustrated in FIG. 15, the means may include a pivot joint 1568 coupling the bracket extension and the mounting bracket. In some embodiments, the means may further include one or more linkages 1570 coupling the bracket extension to the pivot joint 1568. For example, in some embodiments, the pivot joint 1568 and the one or more linkages 1570 may make up a scissor extension mechanism that is extendable from and retractable into the mounting bracket.

In some embodiments, multiple pivot joints 1568 may be included. For example, a first pivot joint may be coupled to a first linkage and a second linkage, the first linkage may be coupled to a third linkage via a second pivot joint, the second linkage may be coupled to a fourth linkage via a third pivot joint, and so on. The one or more linkages 1570 may be extendable from and retractable into the mounting bracket.

In an example operation, the pivot joint 1568 may allow vertical, horizontal, and/or diagonal adjustment of the bracket extension relative to the mounting bracket. For example, the pivot joint 1568 may allow the bracket extension to pivot horizontally left and right about the pivot joint 1568, vertically up and down about the pivot joint 1568, and/or diagonally about the pivot joint 1568. In embodiments including the one or more linkages 1570, the one or more linkages 1570 may rotate about the pivot joint 1568 such that the bracket extension may be adjusted relative to the mounting bracket.

As a result, the bracket extension may be selectively adjusted relative to the mounting bracket. The adjustment of the bracket extension may also adjust a cable retention portion coupled to the bracket extension and one or more cables coupled to the cable retention portion.

FIG. 16 illustrates a portion of an adjustable cable management device 1610. The adjustable cable management device 1610 may include a mounting bracket and a bracket extension coupled to the mounting bracket. The adjustable cable management device 1610 includes a means for selectively adjusting the bracket extension relative to the mounting bracket. As illustrated in FIG. 16, the means may include a piston 1672 coupled to the mounting bracket and the bracket extension.

The piston 1672 may be mobilized utilizing fluid such as hydraulic fluid or air to apply pressure to one side of the piston 1672. The pressure may be applied on a side of the piston 1672 opposite of where the piston 1672 is coupled to the bracket extension. Thus, when pressure is applied, the piston 1672 may be stroked in a first direction, and the bracket extension may be adjusted in the first direction. When the pressure is released, the piston 1672 may be stroked in a second direction, and the bracket extension may be adjusted in the second direction. For example, on the upstroke, the piston 1672 may adjust the bracket extension towards the mounting bracket, and on the downstroke, the piston 1672 may adjust the bracket extension away from the mounting bracket. In another example, on the upstroke, the piston 1672 may adjust the bracket extension away from the mounting bracket, and on the downstroke, the piston 1672 may adjust the bracket extension towards the mounting bracket.

As a result, the bracket extension may be selectively adjusted relative to the mounting bracket. The adjustment of the bracket extension may also adjust a cable retention portion coupled to the bracket extension and one or more cables coupled to the cable retention portion.

As previously mentioned, FIGS. 7-16 the means for selectively adjusting the bracket extension relative to the mounting bracket illustrated in FIGS. 7-16 may be utilized in the PV systems 100, 200, 300 of FIGS. 1-3 and/or the adjustable cable management devices 410, 510 or 610 of FIGS. 4A and 4B, FIGS. 5A-5C, and FIGS. 6A-6C. Furthermore, the components illustrated in FIGS. 7-16 and described with reference to FIGS. 7-16 may be similar to, have similar features as, or perform similar functions as similarly named components described throughout this disclosure.

The various features illustrated in the drawings may be, but are not necessarily, drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An adjustable cable management device, the adjustable cable management device comprising:
a mounting bracket configured to be coupled to a center structure of a photovoltaic (PV) system;
a bracket extension coupled to the mounting bracket;
a means for selectively adjusting the bracket extension relative to the mounting bracket; and
a cable retention portion coupled to the bracket extension, the cable retention portion configured to be coupled to one or more cables.

2. The adjustable cable management device of claim 1, wherein the mounting bracket includes an engaging portion configured to engage a receiving portion of the center structure.

3. The adjustable cable management device of claim 2, wherein the engaging portion is a hook and the receiving portion is a slot.

4. The adjustable cable management device of claim 1, wherein the cable retention portion is a clamp.

5. The adjustable cable management device of claim 1, wherein the cable retention portion is coupled to a messenger line, and the messenger line is coupled to one or more cable hangers configured to receive one or more cables.

6. The adjustable cable management device of claim 1, wherein the mounting bracket includes one or more apertures, the bracket extension includes one or more apertures, and the means for selectively adjusting the bracket extension relative to the mounting bracket is a fastener that extends through at least one of the one or more apertures of the mounting bracket and at least one of the one or more apertures of the bracket extension such that the bracket extension is adjustable relative to the mounting bracket when the fastener is loosened, disengaged, or removed.

7. The adjustable cable management device of claim 1, wherein the means for selectively adjusting the bracket extension relative to the mounting bracket is a bearing positioned between the mounting bracket and the bracket extension.

8. The adjustable cable management device of claim 7, wherein the mounting bracket includes a first guiderail and the bracket extension includes a second guiderail mated with the first guiderail, the bearing positioned between the first guiderail and the second guiderail.

9. The adjustable cable management device of claim 7, wherein the mounting bracket includes a protrusion or a recess and the bracket extension includes a sliding carriage, the bearing configured to engage the protrusion or the recess such that the bearing is positioned between the mounting bracket and the sliding carriage.

10. The adjustable cable management device of claim 1, wherein the mounting bracket includes an outer tube, the bracket extension includes an inner tube disposed at least partially within the outer tube, and the means for selectively adjusting the bracket extension relative to the mounting bracket is an outer diameter of the inner tube being lesser than an inner diameter of the outer tube.

11. The adjustable cable management device of claim 1, wherein the means for selectively adjusting the bracket extension relative to the mounting bracket includes a pivot joint coupling the bracket extension and the mounting bracket.

12. The adjustable cable management device of claim 11, wherein the means for selectively adjusting the bracket extension relative to the mounting bracket further includes one or more linkages coupling the bracket extension to the pivot joint.

13. The adjustable cable management device of claim 1, wherein the mounting bracket includes a fastener having a set of threads, the bracket extension includes a traveler having a corresponding set of threads, and the means for selectively adjusting the bracket extension relative to the mounting bracket is engagement of the set of threads with the corresponding set of threads such that, when the set of threads and the corresponding set of threads are threaded together in a first direction, the traveler is mobilized in a first direction and, when the set of threads and the corresponding set of threads are threaded together in a second direction, the traveler is mobilized in a second direction.

14. The adjustable cable management device of claim 1, wherein the means for selectively adjusting the bracket extension relative to the mounting bracket includes a piston coupled to the mounting bracket and the bracket extension, the piston adjusting the bracket extension in a first direction when the piston is stroked in a first direction and the piston adjusting the bracket extension in a second direction when the piston is stroked in a second direction.

15. The adjustable cable management device of claim 1, wherein the means for selectively adjusting the bracket extension relative to the mounting bracket includes one or more flexural joints extending from an outer surface of the bracket extension that contact an inner surface of the mounting bracket, the flexural joints configured to adjust the bracket extension to a first position when engaged in a first direction and to a second position when engaged in a second direction.

16. An adjustable cable management device, the adjustable cable management device comprising:
a mounting bracket configured to be coupled to a center structure of a photovoltaic (PV) system, the mounting bracket including one or more apertures;
a bracket extension coupled to the mounting bracket, the bracket extension including one or more apertures;
a fastener extending through at least one of the one or more apertures of the mounting bracket and at least one of the one or more apertures of the bracket extension such that the mounting bracket is coupled to the bracket extension, the fastener allowing the bracket extension to be selectively adjusted relative to the mounting bracket when the fastener is loosened, disengaged, or removed; and
a cable retention portion coupled to the bracket extension, the cable retention portion configured to be coupled to one or more cables.

17. The adjustable cable management device of claim 16, wherein the mounting bracket includes an engaging portion configured to engage a receiving portion of the center structure.

18. The adjustable cable management device of claim 16, wherein the cable retention portion is coupled to a messenger line, and the messenger line is coupled to one or more cable hangers configured to receive one or more cables.

19. The adjustable cable management device of claim 16, wherein the mounting bracket includes a first arm having a first aperture and a second arm having a second aperture,
wherein the bracket extension is positioned between the first arm and the second arm, and
wherein the fastener extends through the first aperture, through one of the one or more apertures of the bracket extension, and through the second aperture.

20. The adjustable cable management device of claim 16, wherein the bracket extension is coupled to the mounting bracket via a pivot joint,
wherein the mounting bracket includes a first arm having two or more apertures and a second arm having two or more apertures such that each aperture of the second arm aligns with a respective aperture of the first arm,
wherein the bracket extension is positioned between the first arm and the second arm, and
wherein the fastener extends through at least one of the two or more apertures of the first arm, at least one of the two or more apertures of the second arm, and at least one of the one or more apertures of the bracket extension, the fastener allowing the bracket extension to be selectively adjusted relative to the mounting bracket about the pivot joint when the fastener is disengaged or removed.
